(19) United States
(12) Patent Application Publication
(10) Pub. No.: US 2026/0345426 A1
(43) Pub. Date: Nov. 5, 2026

(54) MASSAGE UNIT AND MASSAGE MACHINE

(71) Applicant: FUJI Medical Instruments MFG. CO.,LTD., Osaka-shi, Osaka (JP)

(72) Inventors: Toshihisa YOSHIDA, Osaka (JP); Yasuki MAKISHI, Osaka (JP); Takeo FUKUNAGA, Osaka (JP); Nobuko NAKANO, Osaka (JP); Haipeng GUO, Shanghai (CN)

(21) Appl. No.: 19/484,745

(22) PCT Filed: Jun. 12, 2024
(86) PCT No.: PCT/CN2024/098631

§ 371 Date: Nov. 14, 2025

(30) Foreign Application Priority Data
Jun. 12, 2023 (CN) 202310690073.7
Nov. 30, 2023 (JP) 2023/202635

(51) Int. Cl. A61H 7/00; A61H 23/00; A61H 23/02

(52) U.S. Cl. CPC A61H 7/007; A61H 23/006; A61H 23/02; A61H 2201/0149; A61H 2201/149; A61H 2201/5007; A61H 2201/5023; A61H 2201/5064; A61H 2205/062; A61H 2205/081

(57) ABSTRACT

A massage unit is provided that includes a pair of treatment elements, a kneading mechanism configured to move the pair of treatment elements in a manner such that the center of each of the treatment elements describes a trajectory having widths in an up-down direction and a left-right direction, a beating mechanism configured to move the pair of treatment elements back and forth in a front-rear direction, a width adjustment mechanism configured to adjust a width between the pair of the treatment elements in the left-right direction, and a linkage linking the kneading mechanism, the beating mechanism, and the width adjustment mechanism, the linkage moving in the left-right direction through the width adjustment mechanism.

### CROSS-REFERENCE TO RELATED APPLICATIONS

This application is a U.S. national stage application of International Application No. PCT/JP2024/098631, filed on Jun. 12, 2024. This application claims priority to Chinese Patent Application No. 202310690073.7, filed on Jun. 12, 2023 and Japanese Patent Application No. 2023/202635, filed on Nov. 30, 2023.

### BACKGROUND

### Technical Field

The present disclosure relates to a massage unit and a massage machine.

### Background Information

In massage machines, a massage machine that connects a kneading shaft that transmits kneading actions and a beating shaft that transmits beating actions has been disclosed (e.g., Japanese Patent No. 7060224 (Patent Document 1)). By such configuration, it is possible to add a treatment mode.

### SUMMARY

In the structure of Patent Document 1, a movement range of a treatment element in the width direction is narrow, making it difficult to perform over a wide range.

The objective of the present disclosure is to provide a massage unit and a massage machine with a simple structure, which can stably perform treatment over a wide range in the width direction.

In order to achieve the above objective, the massage unit of the present disclosure comprises: a pair of treatment elements; a kneading mechanism being capable of moving the pair of treatment elements in a manner such that the centers of the treatment elements each describes a trajectory having widths in an up-down direction and a left-right direction; a beating mechanism being capable of moving the pair of treatment elements back and forth in a front-rear direction; a width adjustment mechanism being capable of adjusting the width between the pair of the treatment elements in the left-right direction; and a linkage linking the kneading mechanism, the beating mechanism, and the width adjustment mechanism, the linkage moves in the left-right direction through the width adjustment mechanism.

The massage unit and massage machine according to the present disclosure can stably perform treatment over a wide range in the width direction, while having a simple structure.

### BRIEF DESCRIPTION OF THE DRAWINGS

FIG. 1 is a perspective view of a massage machine according to an embodiment.

FIG. 2 is a front view of a backrest.

FIG. 3 is a front view of a backrest with another structure.

FIG. 4 is a front view of a backrest with another structure.

FIG. 5 is a front view of a backrest with another structure.

FIG. 6 is a functional block diagram of a massage unit.

FIG. 7 is a perspective view from a front side of the massage unit.

FIG. 8 is a perspective view from a back side of the massage unit.

FIG. 9 is a front view of the massage unit.

FIG. 10 is a sectional view of the massage unit shown in FIG. 9 cut along an X-X line.

FIG. 11 is a sectional view of the massage unit shown in FIG. 9 cut along an XI-XI line.

FIG. 12 is a sectional view of the massage unit shown in FIG. 9 cut along an XII-XII line.

FIG. 13 is a perspective view from a front of a treatment portion.

FIG. 14 is a perspective view from a back of the treatment portion.

FIG. 15 is a side view of the treatment portion.

FIG. 16 is a schematic diagram showing the body of the recipient and the movement range of a treatment element.

FIG. 17 is a flowchart showing the steps of treatment.

FIG. 18 is a flowchart showing the body measurement action.

FIG. 19a is a diagram presenting the left-right positions of the treatment element and a first width adjustment guide during kneading.

FIG. 19b is a diagram showing the trajectory of the treatment element.

FIG. 20a is a diagram presenting the up-down positions of the treatment element and the drive shaft during kneading.

FIG. 20b is a diagram showing the trajectory of the treatment element.

### DETAILED DESCRIPTION OF EMBODIMENTS

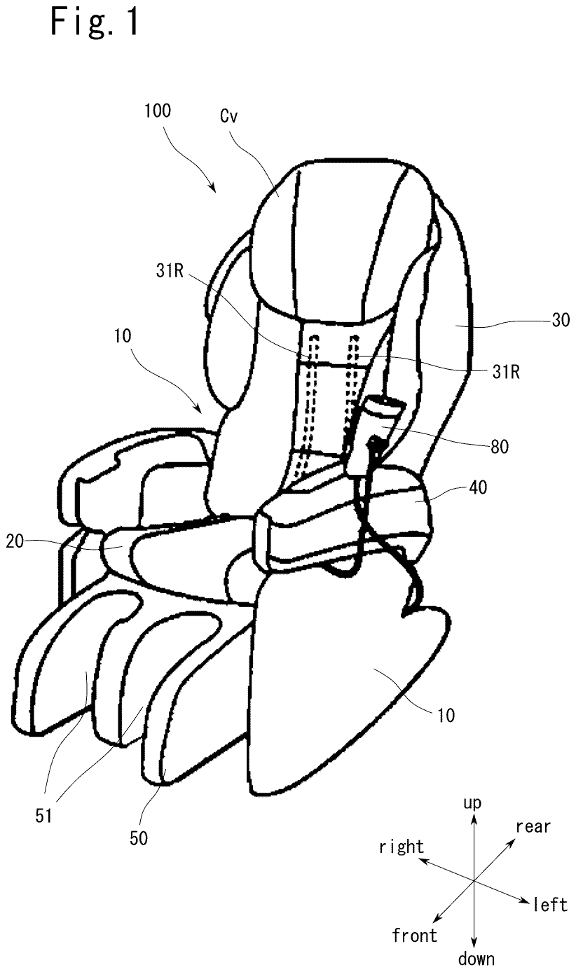

FIG. 1 is a perspective view of a massage machine 100 according to an embodiment. The massage machine 100 shown in FIG. 1 is in a state covered by a cover Cv made of natural leather, synthetic leather, fabric, etc.

In addition, in the following description, a front side (leading side) of a recipient sitting on the massage machine 100 is referred to as the “front side”, and a rear side (back side) of the recipient sitting on the massage machine 100 is referred to as the “rear side”. In addition, an upper side (head side) of the recipient sitting on the massage machine 100 is referred to as the “upper side”, and a lower side (foot side) of the recipient sitting on the massage machine 100 is referred to as the “lower side”. Furthermore, a right side of the recipient sitting on the massage machine 100 is referred to as the “right side”, and a left side of the recipient sitting on massage machine 100 is referred to as the “left side”. In addition, the so-called “extending along” a specified direction includes not only the case of strictly extending along the specified direction, but also the case of extending along a direction inclined within a range of less than 45° relative to the exact direction.

### Massage Machine 100

The massage machine 100 provides a full-body massage for the recipient it supports. As shown in FIG. 1, the massage machine 100 comprises a base 10, a seat 20, a backrest 30, an arm treatment part 40, and a leg treatment part 50.

The seat 20 and the backrest 30 support the body of the recipient. The seat 20 supports the buttocks and thighs of the recipient. The seat 20 may also have an inflation and contraction part for treating the buttocks or thighs. The inflation and contraction part, for example, has a bag (so-called airbag) that can repeatedly expand and contract by filling and discharging air. In addition, the inflation and contraction part used in the following description has the same structure.

The backrest 30 supports the shoulders, waist, and dorsal region of the recipient. The backrest 30 is erected upward from the rear of the seat 20. The backrest 30 includes a so-called tilting function that performs a tilting movement of the upper part backward relative to the seat 20 by means of a tilting motor (not shown).

A massage unit 60 described below is configured within the backrest 30 and is guided by rails 31R and 31L provided in the backrest 30 to move up and down along the backrest 30. In addition, the backrest 30 may also have an inflation and contraction part for treating the shoulders and upper arms of the recipient. In addition, the backrest 30 and the massage unit 60 are described in detail below.

The base 10 supports the seat 20 and the backrest 30. The arm treating part 40 is provided on the base 10, and is provided vertically upward from both ends of the seat 20. The arm treatment part 40 has a inflation and contraction part (not shown) therein, which treats the arms of the recipient through the inflation and contraction of the inflation and contraction part.

The leg treatment part 50 supports lower limbs of the recipient. The lower limb, such as the shank, is the part of the leg that is lower than the knee. The leg treatment part 50 is positioned downward from the front of the seat 20. The lower part of the leg treatment part 50 rotates upward about the front of the seat 20 as an axis. In addition, the rotational movement of the leg treatment part 50 may be performed synchronously with the tilting movement of the backrest 30. In addition, the tilting movement of the backrest 30 and the rotating movement of the leg treatment part 50 can also be independently performed.

The leg treatment part 50 has a recess 51 that can be inserted by a lower limb of the recipient. The recess 51 is configured with, for example, an inflation and contraction part, which is constructed to apply treatment by pressing the inserted lower limb.

### Backrest 30

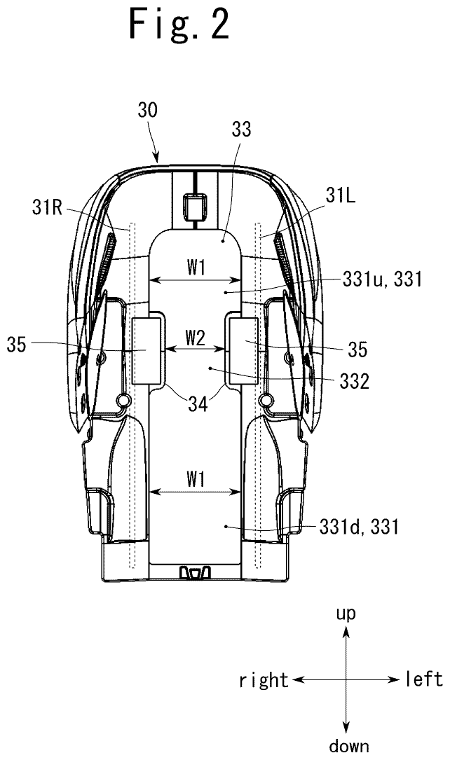

FIG. 2 is a front view of a backrest 30. The backrest 30 shown in FIG. 2 is in the state where the cover Cv has been removed. As shown in FIG. 2, when viewed from the front, the backrest 30 forms a hole 33 extending in the up-down direction in the central portion. The hole 33 extends upward from the lower end of the backrest 30.

As shown in FIG. 2, the hole 33 includes a first area 331 and a second area 332. The width of the first area 331 in the left-right direction is the first width W1. Furthermore, the width of the second area 332 in the left-right direction is the second width W2, which is narrower than the first width W1. As shown in FIG. 2, the hole 33 in the backrest 30 includes an upper first area 331u and a lower first area 331d. The second area 332 is provided between the upper first area 331u and the lower first area 331d, and is continuously formed with the first area 331u and the first area 331d.

The upper first area 331u of the hole 33 in the backrest 30 is a position corresponding to the shoulders of the seated recipient. In addition, the lower first area 331d is a position corresponding to the waist of the seated recipient. In addition, the second area 332 is a position corresponding to the dorsal region of the seated recipient.

A treatment element 622 of the massage unit 60 protrudes toward the front of the backrest 30 through the hole 33. In the massage machine 100, the width of the treatment for the shoulders and waist of the recipient is wider in the left-right direction, while the width of the treatment applied to the dorsal region of the recipient in the left-right direction is narrower than that for the shoulder and waist. As a result, in the body of the recipient, the treatment element 622 may provide kneading and beating over a wide range in the left-right direction on the shoulders and waist, where muscles are distributed over a wide range in the left-right direction.

On the other hand, there are muscles in the central section of the dorsal region in the left-right direction, but there are not many muscles distributed at the ends. Therefore, the treatment effect of the treatment element 622 is low at the ends of the dorsal region in the left-right direction. That is, in the portion corresponding to the dorsal region, even if the treatment element 622 is moved over a wide range in the left-right direction, the effect is low, and thus the second area 332 with the second width W2 is formed in the portion of the hole 33 corresponding to the dorsal region.

Lightweight can be achieved by forming the hole 33 in the backrest 30. On the other hand, if the hole 33 is too large, there may be a decrease in the rigidity of the backrest 30, and there may also be a situation where the body of the recipient sinks into the hole 33. By forming the second area 332 in the hole 33 with the second width W2 narrower than the first width W1 of the first area 331, it is possible to suppress the decrease in rigidity of the backrest 30 and also suppress the sinking of the body of the recipient.

The portion adjacent to the second area 332 of the backrest 30 in the left-right direction protrusions 34 are the portions adjacent to the second area 332 of the backrest 30 in the left-right direction, which protrude toward the inner side of the backrest 30 from an opening portion. An inflation and contraction part 35 is provided on the front surface of the protrusion 34. The inflation and contraction part 35 expands, for example, by supplying compressed air from an air compressor (not shown) and contracts by removing the air. That is, the inflation and contraction part 35 is a bag (a so-called airbag) that can be repeatedly expanded and contracted by air.

The inflation and contraction parts 35 simultaneously or alternately presses the left and right ends of the dorsal region of the body of the recipient toward the front and toward the inside of the left-right side during expansion. The inflation and contraction part 35 is a structure that performs treatment by pressing the body of the recipient through an expansion caused by filling air, and compared with the kneading and beating implemented by the treatment element 622, it can gently perform treatment.

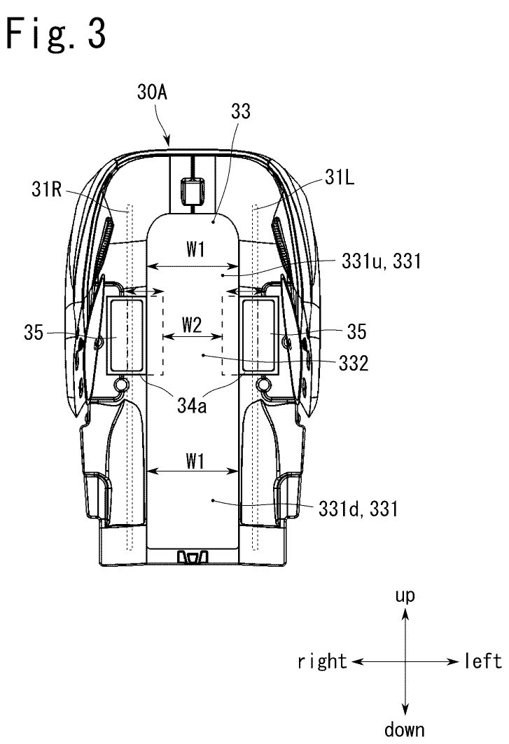

FIG. 3 is a front view of a backrest 30A with another structure. The backrest 30A shown in FIG. 3 has a pair of movable protrusions 34a that are movable in the left-right direction. The protrusions 34a are movable, for example, between the first width W1 and the second width W2 in a manner that approach or separate from each other in the left-right direction. Additionally, in the massage machine 100, the protrusions 34a may also be configured to move inwards as the inflation and contraction part 35 expanding, and move outwards as the inflation and contraction part 35 contracting.

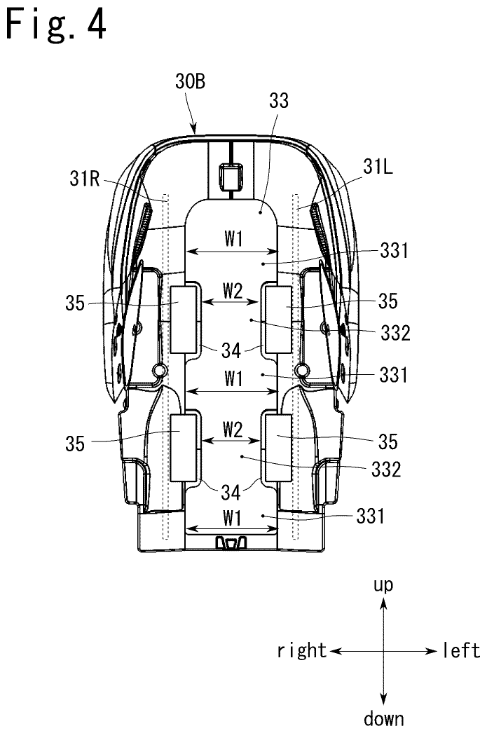

FIG. 4 is a front view of a backrest 30B with another structure. The backrest 30B shown in FIG. 4 includes two pairs of protrusions 34. Thus, the hole 33 includes two second areas 332 along the up-down direction. Moreover, a first area 331 is arranged between adjacent second areas 332 along the up-down direction of the hole 33. As a result, due to the protrusions 34 supporting multiple portions of the body of the recipient, it is possible to prevent the body of the recipient from sinking into the hole 33. Additionally, the backrest 30B may also include a structure with three or more second areas 332.

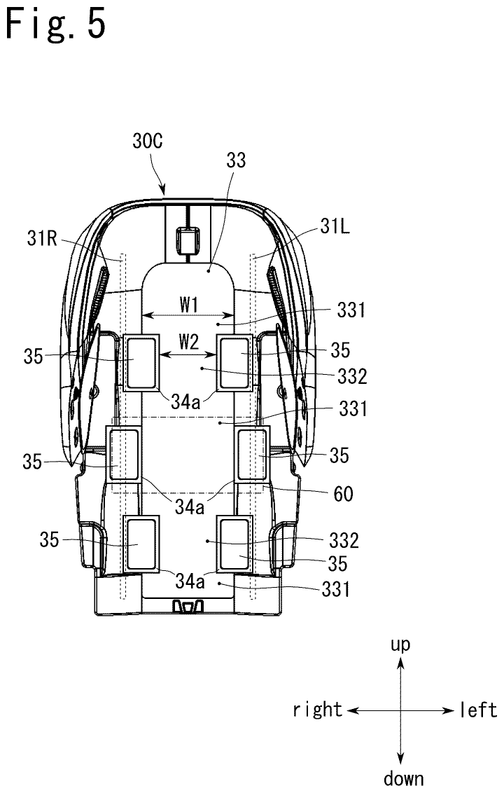

FIG. 5 is a front view of a backrest 30C with another structure. The backrest 30C shown in FIG. 5 includes three pairs of movable protrusions 34a. The three pairs of protrusions 34a are arranged in an up-and-down configuration. The three pairs of protrusions 34a are arranged, for example, at portions corresponding to the shoulders, dorsal region, and waist of the body of the recipient.

As shown in FIG. 5, the movement of the protrusions 34a in the left-right direction is synchronized with the movement of the massage unit 60 in the up-down direction. For example, the protrusions 34a overlapping with the massage unit 60 in the front-rear direction move outwards in the left-right direction. As a result, the treatment range of the massage unit 60 in the left-right direction can be expanded. That is, the massage unit 60 can provide treatment to the body of the recipient in a wide range.

The protrusions 34a other than those protrusions 34a which overlap with the massage unit 60 are arranged on the inner side. Therefore, the protrusions 34a arranged on the inner side support the body of the recipient, which can prevent the body of the recipient from sinking into the hole 33. Additionally, the protrusions 34a are not limited to three pairs. Additionally, at least one pair of protrusions 34 can also be non-movable.

In addition, the protrusions 34a may also be configured to be movable in the left-right and up-down direction. By moving the protrusions 34a up and down, the position of the second area 332 in the up-down direction can be changed. By adopting such a structure, it is possible to adjust the narrow width area in the left-right direction where the treatment element 622 can protrude forwards from the hole 33. In addition, the protrusions 34a may also be moved in a manner of changing the width in the left-right direction. In this way, due to the movable protrusions 34a, it is possible to increase the area of the body of the recipient that can be treated with the treatment element 622 while maintaining the rigidity of the backrest 30. In addition, the narrow width area in the left-right direction may be adjusted according to the body of the recipient, and treatment can be performed according to the body of the recipient.

### Structure of the Massage Unit 60

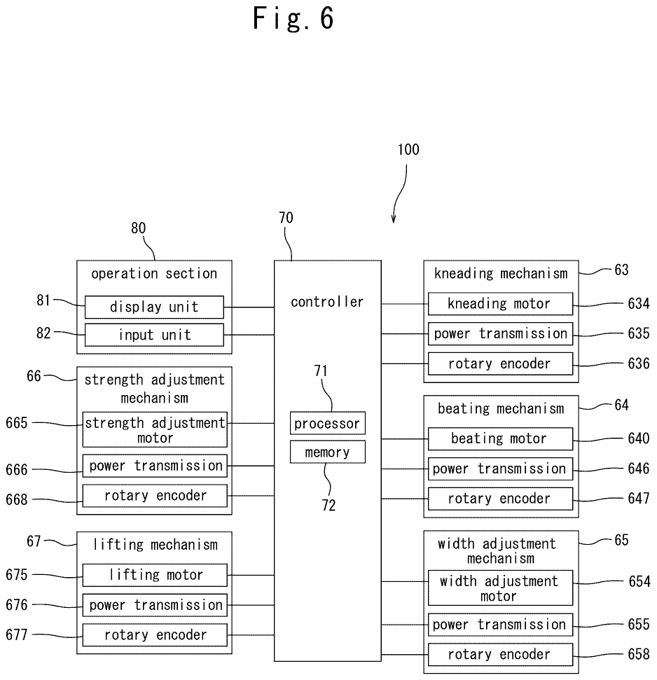

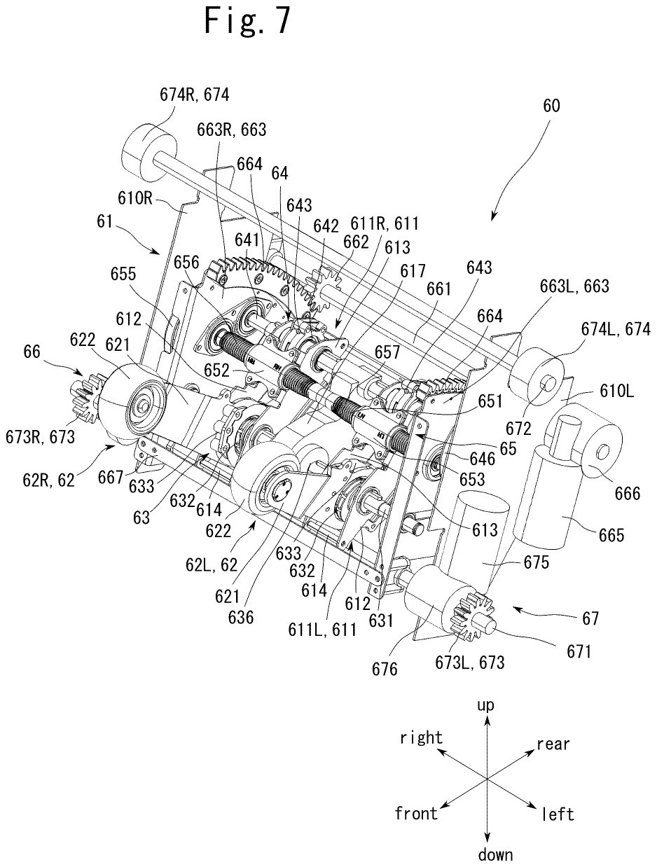

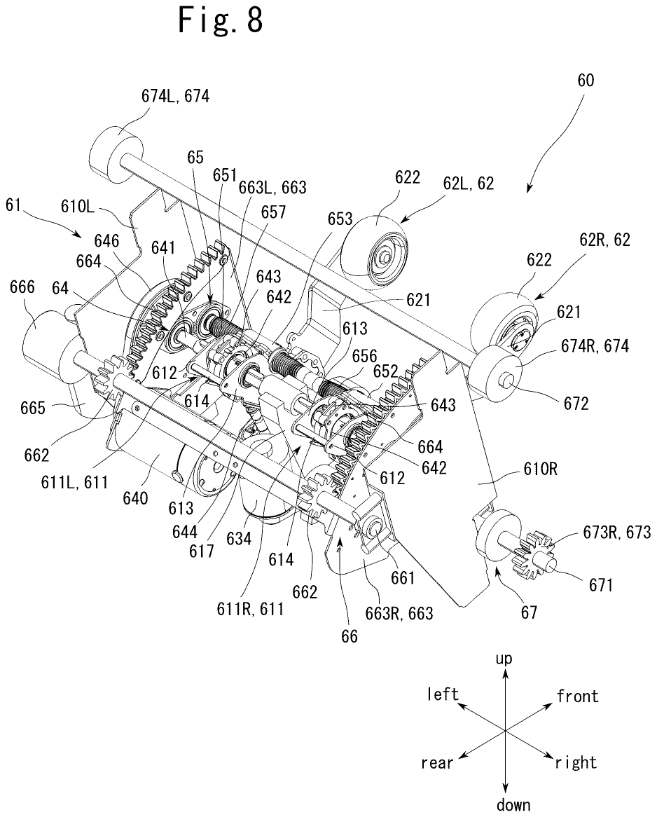

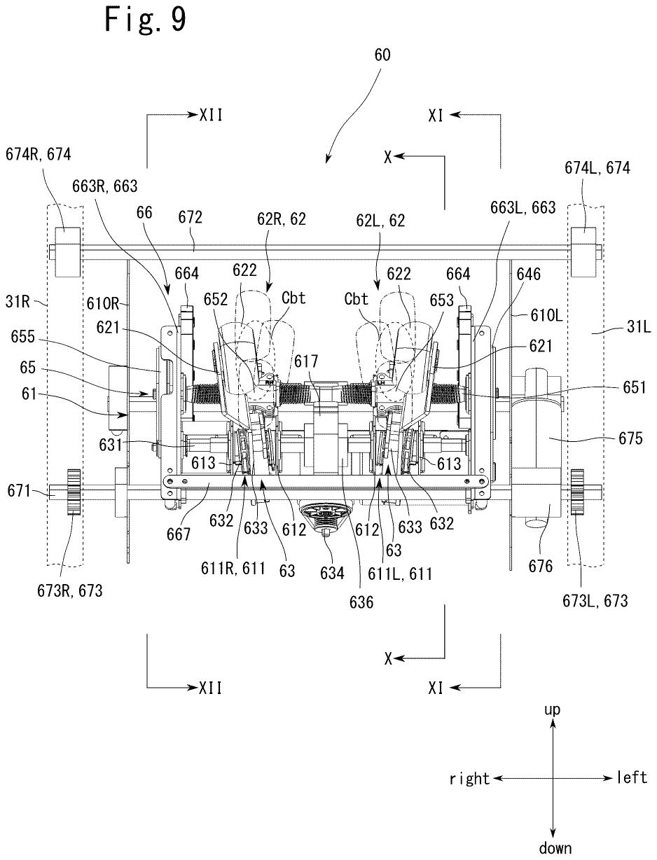

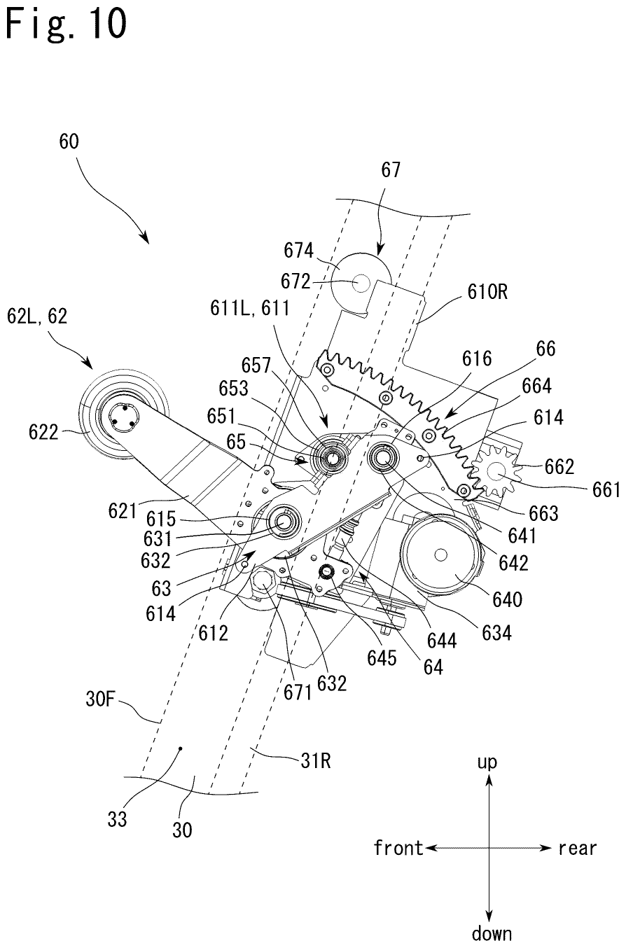

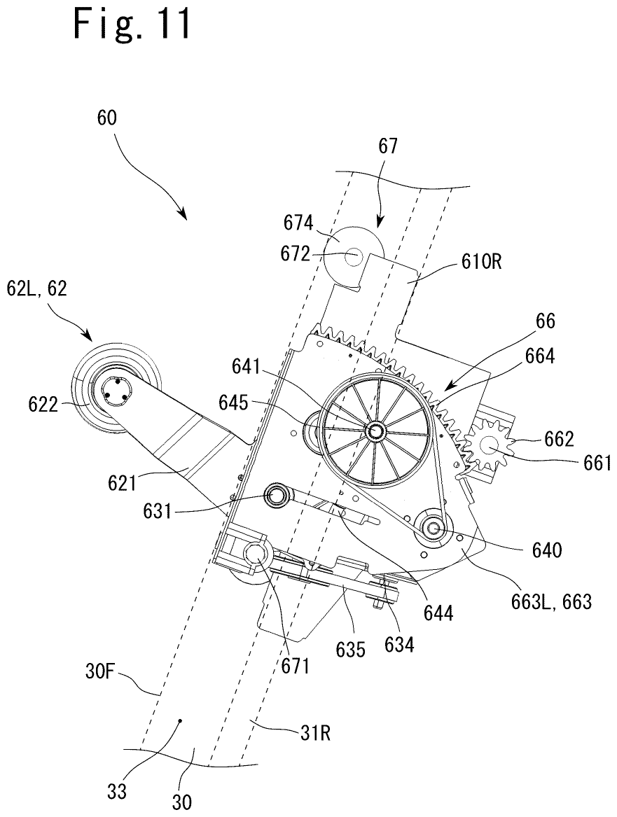

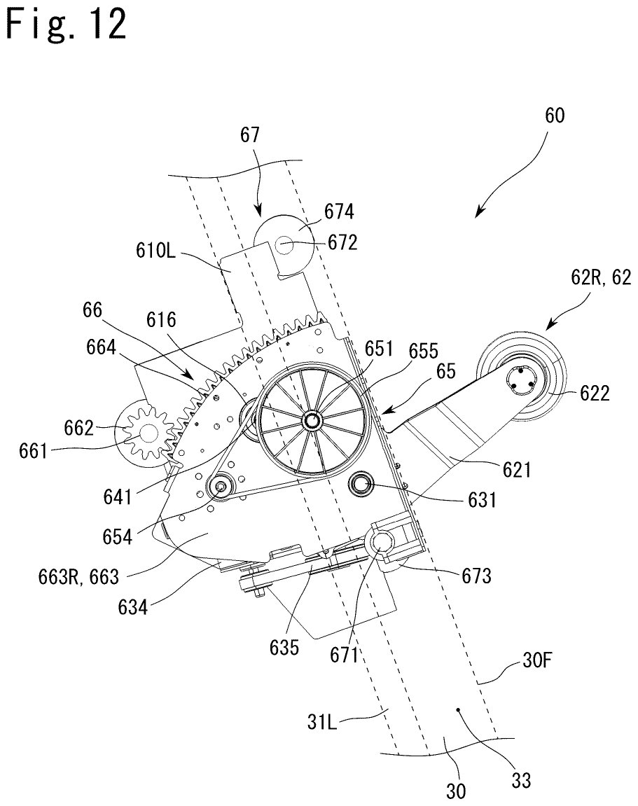

The massage unit 60 then will be described in detail referred to the figures. FIG. 6 is a functional block diagram of the massage unit 60. FIG. 7 is a perspective view from the front side of the massage unit 60. FIG. 8 is a perspective view from the back side of the massage unit 60. FIG. 9 is a front view of the massage unit 60. FIG. 10 is a sectional view of the massage unit 60 shown in FIG. 9 along an X-X line. FIG. 11 is a sectional view of the massage unit 60 shown in FIG. 9 along an XI-XI line. FIG. 12 is a sectional view of the massage unit 60 shown in FIG. 9 along an XII-XII line.

As shown in FIGS. 6, 7 and 8, the massage machine includes the massage unit 60 and a controller 70. The massage unit 60 includes a base 61, a pair of treatment parts 62, a kneading mechanism 63, a beating mechanism 64, a width adjustment mechanism 65, a strength adjustment mechanism 66, and a lifting mechanism 67.

### Controller 70

As shown in FIG. 6, the controller 70 is connected to the kneading mechanism 63, the beating mechanism 64, the width adjustment mechanism 65, the strength adjustment mechanism 66, and the lifting mechanism 67 to obtain information from each mechanism and control their actions. When describing each mechanism, detailed description of the connection status between the controller 70 and each mechanism is provided as needed.

As shown in FIG. 6, the controller 70 includes a processor 71 and a storage unit 72. The processor 71 for example includes arithmetic circuits such as CPU (Central Processing Unit) and MPU (Micro Processing Unit). Additionally, the processor 71 controls the massage unit 60 based on arithmetic processing using information from various mechanisms and information stored in the storage unit 72.

The storage unit 72 includes semiconductor memory elements such as ROM (Read Only Memory) and RAM (Random Access Memory), portable memory elements such as flash memory, and storage media such as hard disks, or circuits connected with storage elements or storage media. The storage unit 72 stores information from the above-mentioned mechanisms and the information required to control each mechanism.

In the controller 70, the processor 71 may perform calculation using a single circuit, or it may perform calculation using a general-purpose calculation circuit and executing a program stored in the storage unit 72.

As shown in FIG. 6, an operation section 80 is connected to the controller 70 to receive manipulations from the recipient. The operation section 80 has a display unit 81 and an input unit 82. The display unit 81 includes a display device for displaying the action status of the massage unit 60. As display devices, examples include liquid crystal panels, organic EL panels, and other display panels. Additionally, it may include a structure utilizing LED activation or deactivation to convey information.

The input unit 82 includes an input device that accepts input from the recipient or operator. Examples of input devices include buttons, sliding buttons, volume switches, etc. Additionally, a touch panel that is installed on the surface of the display unit 81 and accepts input through contact can also be used.

Additionally, in the massage machine 100 of this embodiment, a structure including the operation section 80 is shown, but a portable terminal such as a smartphone held by the recipient can also be used. In such a case, the massage machine 100 is configured to comprise a connector connected to a portable terminal. Additionally, it can also be a structure that comprises both the operation section 80 and the connector.

### Base 61

As shown in FIG. 7, the base 61 includes a left-side base plate 610L and a right-side base plate 610R. The left-side base plate 610L and the right-side base plate 610R are plate-shaped members arranged symmetrically along the left-right direction, and configured to face each other in the left-right direction. The base 61 is installed with a strength adjustment shaft 661 and a strength adjustment motor 665 of the strength adjustment mechanism 66 as described below, as well as a drive shaft 671, a driven shaft 672, and a lifting motor 675 of the lifting mechanism 67 thereon.

A linkage 611 linking the kneading mechanism 63, the beating mechanism 64, and the width adjustment mechanism 65 is provided on the base 61. The linkage 611 includes a first support 612 and a second support 613. The first support 612 and the second support 613 are both flat plate shaped members, which are arranged along the left-right direction of the treatment part 62 and support the treatment part 62.

In the base 61, a pair of linkages 611 are provided on the left and right sides. Moreover, a bracket 617 is provided in the middle of the pair of the linkages 611 in the left-right direction. The bracket 617 supports a below-described kneading shaft 631 of the kneading mechanism 63 and a beating shaft 641 of the beating mechanism 64 in a rotatable manner. In other words, the kneading shaft 631 and the beating shaft 641 are rotatable relative to the bracket 617.

### A Pair of Treatment Parts 62

A pair of treatment parts 62 are symmetrically arranged on the left and right sides. Here, the treatment parts 62 are described using the treatment part 62R located on the right side as a representative. Additionally, in the case of being necessary to distinguish between a pair of treatment parts 62 on the left and right sides, the treatment part 62 on the left side is referred to as the left treatment part 62L, and the treatment part 62 on the right side is referred to as the right treatment part 62R. Additionally, in the following description, in the case of distinguishing other components on the left and right sides, the suffix L is similarly added to those on the left side, and the suffix R is added to those on the right side to distinguish them.

The treatment part 62 includes an arm 621 and a treatment element 622. The arm 621 is a plate-shaped member that extends front-back and up-down, with the treatment element 622 installed at a front end thereof. The treatment element 622 is a revolved body centered on a central axis extending in the left-right direction. Additionally, a revolved body centered on the central axis refers to a three-dimensional shape formed by rotating a figure configured in a plane containing a central axis around the central axis. In addition, in this embodiment, the central axis is an axis perpendicular to one plane of the arm 621, but not limited to being perpendicular. The treatment element 622 applies kneading, beating, and other treatments to the recipient by contacting the body of the recipient. The kneading and beating actions are described in detail below.

A driven ring 633 of the kneading mechanism 63 and a rod connector 645 connected to the rod 644 of the beating mechanism 64 are arranged at a rear end of the arm 621. The driven ring 633 and the rod connector 645 are formed integrally. In addition, the driven ring 633 and the rod connector 645 only need to be a structure that is firmly fixed, for example, they can also be integrally formed. That is, the arm 621 is supported in a forward protruding state by the kneading mechanism 63 and the striking mechanism 64.

### Kneading Mechanism 63

As shown in FIGS. 7, 8, 10, etc., the kneading mechanism 63 has the kneading shaft 631, a kneading cam 632, the driven ring 633, a kneading motor 634, and a power transmission 635. The kneading shaft 631 is a bar member extending in the left-right direction. The kneading shaft 631 supports both ends in the left-right direction in a rotatable manner on a pair of adjustment members 663, which are described below, of the strength adjustment mechanism 66. A rotary encoder 636 is arranged on the kneading shaft 631, and the rotary encoder 636 is connected to the controller 70 (referred to FIG. 6). By obtaining information from the rotary encoder 636, the controller 70 can obtain the rotation speed, the rotation angle, and other status of the kneading shaft 631.

The kneading cam 632 is provided on the kneading shaft 631. The kneading cam 632 can rotate with the kneading shaft 631 and can move in the direction along the axis of the kneading shaft 631. As such a structure, for example, a structure may be adopted in which an inner surface of the through hole of the kneading cam 632 for the kneading shaft 631 passing through or an outer circumferential surface of the kneading shaft 631 has a protrusion protruding radially and has a groove for embedding the protrusion on the other side. However, other structures can also be used.

The kneading cam 632 is shaped as a circular plate, with its center line offsetting from the center line of the kneading shaft 631, that is, eccentric. In addition, a centerline of the kneading cam 632 is inclined relative to a centerline of the kneading shaft 631. In such state, if the kneading shaft 631 rotates, the kneading cam 632 eccentrically rotates and swings in the direction along the axis of the kneading shaft 631.

The driven ring 633 is shaped as a circular ring, and is configured that its inner circumferential surface having an annular shape is slidable in the circumferential direction relative to the outer circumferential surface of the kneading cam 632. The inner circumferential surface of the driven ring 633 and the outer circumferential surface of the kneading cam 632 are formed so as not to move in the axial direction of the kneading shaft 631. As such a structure, for example, a structure in which a convex portion extending along the circumferential direction and a concave portion embedded into the convex portion are formed on the outer circumferential surface of the kneading cam 632 and the inner circumferential surface of the driven ring 633.

As the kneading cam 632 rotating, the driven ring 633 moves along with the movement of the kneading cam 632. That is, when viewed from the front, the driven ring 633 either approaching or separating from the centerline of the kneading shaft 631 due to the rotation of the kneading shaft 631, and moves in a manner that changes its inclination relative to the centerline of the kneading shaft 631. The driven ring 633 is fixed to the arm 621 of the treatment part 62. Therefore, the arm 621 moves along with the movement of the driven ring 633. Thus, the center of the treatment element 622 arranged at the end of the arm 621 on the front side moves in a manner that depicts a trajectory Cbt with widths along the up-down and left-right directions (referred to FIG. 9).

In addition, the trajectory Cbt can be exemplified as a closed curve shaped trajectory. Here, “closed curve” refers to a shape where the starting and ending points are consistent. For example, “closed curve” should be understood to include shapes such as arcs, ellipses, rings, polygons, etc.

The kneading motor 634 and the power transmission 635 are installed on the bracket 617. The power transmission 635 is a structure using pulleys and belts to transmit the power of the kneading motor 634 to the kneading shaft 631. The power transmission 635 slows down the rotating speed and increases the output torque of the kneading motor 634. However, the power transmission 635 can also be configured to increase the rotating speed and reduce the output torque of the kneading motor 634. Alternatively, the power transmission 635 can be composed of gears. In addition, it can also be configured to directly transmit the power of the kneading motor 634 to the kneading shaft 631. In such a case, the power transmission 635 can be omitted.

The kneading motor 634 is connected to the controller 70 and driven based on instructions from the controller 70. In addition, the controller 70 can change the treatment intensity and speed of the treatment element 622 performing kneading during the kneading action by changing the torque and speed of the kneading motor 634.

The power from the output shaft of the kneading motor 634 is transmitted to the kneading shaft 631 via the power transmission 635. Alternatively, the power transmission 635 may be a structure that is connected with the controller 70 and switches between a state in which power is transmitted to the kneading motor 634 and a state in which power is not transmitted to the kneading motor 634. In such a case, the switching between transmitting power and not transmitting power can be exemplified by switching using a clutch, which is controlled by the controller 70. The power transmissions 646, 655, 666, 676 described later may also have the same structure.

The kneading cams 632 and the driven rings 633 are structures provided on the left treatment part 62L and the right treatment part 62R, and each has the same structure.

### Beating Mechanism 64

As shown in FIGS. 7, 8, 10, etc., the beating mechanism 64 comprises a beating motor 640, a beating shaft 641, a beating cam 642, a driven ring 643, a rod 644, a rod connector 645 and a power transmission 646. The beating shaft 641 is a rod member extending in the left-right direction. The beating shaft 641 supports both ends in the left-right direction on the pair of adjustment members 663 of the strength adjustment mechanism 66 in a rotatable manner. In addition, when viewed from the front, the beating shaft 641 is positioned higher than the kneading shaft 631.

The beating cam 642 is provided on the beating shaft 641. The beating cam 642 can rotate with the beating shaft 641, and can move in the direction along the axis of the beating shaft 641. As such a structure, for example, a structure may be adopted in which an inner surface of the through hole of the beating cam 642 for the beating shaft 641 passing through or an outer circumferential surface of the beating shaft 641 has a protrusion protruding radially and has a groove for embedding the protrusion on the other side. However, other structures can also be used.

The beating cam 642 is shaped as a circular plate, with its centerline offsetting from the centerline of the kneading shaft 641, that is, eccentric. Therefore, the beating cam 642 rotates eccentrically.

The driven ring 643 is shaped as a circular ring, and is configured that its inner circumferential surface having an annular shape is slidable in the circumferential direction relative to the outer circumferential surface of the beating cam 642. The inner circumferential surface of the driven ring 643 and the outer circumferential surface of the beating cam 642 are formed so as not to move in the axial direction of the beating shaft 641. As such a structure, for example, a structure in which a convex portion extending along the circumferential direction and a concave portion embedded into the convex portion are formed on the outer circumferential surface of the beating cam 642 and the inner circumferential surface of the driven ring 643.

As the beating cam 642 rotating, the driven ring 643 moves along with the movement of the beating cam 642. That is, when viewed from the front, the driven ring 643 moves in a manner that approaches or separates from the centerline of the beating shaft 641 while maintaining a certain angle with the centerline of the beating shaft 641. In the massage unit 60, the driven ring 643 moves back and forth in the axial direction, such as the up-down direction, relative to the beating shaft 641.

One end of the rod 644 is connected to the driven ring 643 via a universal joint. In addition, the other end of the rod 644 is connected to the rod connector 645 via a universal joint. The rod connector 645 is integrally installed to the arm 621. The rod connector 645 can swing about the centerline of the kneading shaft 631. One end of the rod 644 is connected to the driven ring 643 that moves linearly, and the other end thereof is connected to a rod connector 645 that may swing.

Thus, the rod 644 converts the linear movement of the driven ring 643 into the swing movement of the rod connector 645. By the swing of the rod connector 645, the treatment element 622 installed on the arm 621 moves back and forth in the front-rear direction. Thus, the pair of treatment elements 622 perform a beating action on the body of the recipient. An example of a beating action can be given as the pair of treatment elements 622 moving back and forth alternately in the front-rear direction.

The beating motor 640 is connected with the controller 70 and operates based on instructions from the controller 70. The beating motor 640 is installed to an adjusting member 663L on the left side of the strength adjustment mechanism 66. In addition, the controller 70 can also change the treatment intensity and speed of the treatment element 622 performing beating during the beating action by changing the torque and speed of the beating motor 640.

Similar to the beating motor 640, the power transmission 646 is provided on the adjustment member 663L on the left side. The power transmission 646 is a structure using pulleys and belts to transmit the power of the beating motor 640 to the beating shaft 641. Here, the power transmission 646 slows down the rotating speed and increases the output torque of the beating motor 640. However, the power transmission 646 can also be a structure that increases the rotating speed and reduces the output torque.

Alternatively, the power transmission 646 can be a structure using gears. Alternatively, it can be configured to directly transmit the power of the beating motor 640 to the beating shaft 641. In such a case, the power transmission 646 can also be omitted.

The beating cams 642, the driven rings 643, the rods 644, and the rod connectors 645 are structures provided in both the left treatment part 62L and the right treatment part 62R, and each has the same structure. In addition, the beating cams 642 are of the same shape, but are offset and eccentric in the circumferential direction by alternately beating the left and right treatment elements 622 on the body of the recipient.

The controller 70 controls the kneading motor 634 and the beating motor 640 to enable either or both of the kneading mechanism 63 and the beating mechanism 64 to perform kneading only, beating only, or concurrent actions of kneading and beating.

### Width Adjustment Mechanism 65

The width adjustment mechanism 65 adjusts the width of the treatment element 622. As shown in FIGS. 7, 8, 10, etc., the width adjustment mechanism 65 has a width adjustment shaft 651, a first width adjustment guide 652, a second width adjustment guide 653, a width adjustment motor 654, and a power transmission 655. The width adjustment shaft 651 is a bar member extending in the left-right direction. The width adjustment shaft 651 supports both ends in the left-right direction on a pair of adjustment members 663 of the strength adjustment mechanism 66 in a rotatable manner. In addition, when viewed from the front, the width adjustment shaft 651 is arranged between the kneading shaft 631 and the beating shaft 641 in the up-down direction.

A sensor, such as a rotary encoder 658 is arranged on the width adjustment shaft 651, and the rotary encoder 658 is connected to the controller 70 (referred to FIG. 6). By obtaining information from the rotary encoder 658, the controller 70 can obtain the rotation speed, the rotation angle, and other states of the width adjustment shaft 651. In addition, the controller 70 can obtain the position of the treatment parts 62 and the width in the left-right direction between the pair of treatment part 62 based on information from the rotary encoder 658.

The width adjustment shaft 651 is formed with a first thread 656 on the right side and a second thread 657 on the left side. The first thread 656 has left-hand thread shaped protrusions and depressions, and the second thread 657 has right-hand thread shaped protrusions and depressions.

The first width adjustment guide 652 is cylindrical, with left-hand thread shaped protrusions and depressions on its inner circumstantial surface. Moreover, the protrusions and depressions of the first width adjustment guide 652 are configured to mesh with the protrusions and depressions of the first thread 656. Additionally, the second width adjustment guide 653 is cylindrical in shape, with a right threaded shape of concave-convex formed on its inner circumstantial surface. Moreover, the protrusions and depressions of the second width adjustment guide 653 are configured to mesh with the protrusions and depressions of the second thread 657.

By the rotation of the width adjustment shaft 651, the first width adjustment guide 652 and the second width adjustment guide 653 move along the centerline of the width adjustment shaft 651. Due to the protrusions and depressions of the first thread 656 being a left threaded shape and the protrusions and depressions of the second thread 657 being a right threaded shape, the first width adjustment guide 652 and the second width adjustment guide 653 move in opposite directions by rotating the width adjustment shaft 651. To further describe, due to the different spiral directions of the first thread 656 and the second thread 657, the first width adjustment guide 652 and the second width adjustment guide 653 may move in a manner that approaches or separates from each other according to the rotation direction of the width adjustment shaft 651. By combining with the kneading action, the width of the trajectory Cbt in the left-right direction depicted by the center of the treatment element 622 can be adjusted.

The first width adjustment guide 652 is fixed to both the first support 612 and the second support 613 of the linkage 611R on the right side. Additionally, the second width adjustment guide 653 is fixed to both the first support 612 and the second support 613 of the linkage 611L on the left side. Therefore, the first width adjustment guide 652 and the second width adjustment guide 653 moving in a manner of adjusting the width in the left-right direction causes the linkage 611R on the right side and the linkage 611L on the left side to move to separate from or approach to each other in the left-right direction.

In the massage unit 60 of this embodiment, the first width adjustment guide 652 along with the first thread 656, and the second width adjustment guide 653 along with the second thread 657 are composed of a conventional threaded structure, but are not limited to this. For example, a ball screw structure can also be used.

The width adjustment motor 654 is connected with the controller 70 and operates based on instructions from the controller 70. The width adjustment motor 654 is installed to the adjusting member 663R on the right side of the strength adjustment mechanism 66. A power transmission 655 transmits the power of the width adjustment motor 654 to the width adjustment shaft 651. The power transmission 655 is provided on the adjustment member 663R on the right side, similar to the width adjustment motor 654.

The power transmission 655 is a structure using pulleys and belts to slow down the rotating speed and increase the output torque of the width adjustment motor 654. However, the power transmission 655 can also be a structure that increases the rotating speed and reduces the output torque. In addition, the power transmission 655 can also be a structure using gears. It can also be configured to directly transmit the power of the width adjustment motor 654 to the width adjustment shaft 651. In such a case, the power transmission 655 can be omitted.

In addition, in the massage unit 60, it may also be that the beating motor 640 and the power transmission 646 are installed to the adjusting member 663L on the left side, while the width adjusting motor 654 and the power transmission 655 are installed to the adjusting member 663R on the right side.

### Strength Adjustment Mechanism 66

In the massage unit 60, the more the position of the trajectory Cbt depicted by the center of the treatment element 622 protrudes forwards, the more strongly the pressure felt by the body of the recipient. The strength adjustment mechanism 66 has a structure that utilizes this to move the position of the trajectory Cbt depicted by the center of the treatment element 622 forward and backward when a stronger force is required for treatment. That is, the strength adjustment mechanism 66 can adjust the position of the pair of treatment elements 622 in the front-rear direction.

As shown in FIGS. 7, 8, 10, etc., the strength adjustment mechanism 66 includes a strength adjustment shaft 661, a pinion 662, a pair of adjustment members 663, a strength adjustment motor 665, and a power transmission 666.

The strength adjustment shaft 661 is a bar member extending in the left-right direction. The strength adjustment shaft 661 supports both ends in the left-right direction to the left-side base plate 610L and the right-side base plate 610R of the base 61 in a rotatable manner. In addition, a pair of pinions 662 are fixed to the strength adjustment shaft 661. Additionally, a rotary encoder 668 is arranged on the strength shaft 668, and the rotary encoder 668 is connected to the controller 70 (referred to FIG. 6). By obtaining information from the rotary encoder 668, the controller 70 can obtain the rotation speed, the rotation angle, and other states of the strength adjustment shaft 661. The controller 70 can obtain the status of the strength adjustment mechanism 66 based on information from the rotary encoder 668.

The pair of adjusting members 663 are sector-shaped plates when viewed from the side. Moreover, a circular arc-shaped rack 664 is provided in the circular arc portion of the sector shape. In addition, the drive shaft 671 of the lifting mechanism 67, which is described below, passes through the central portion of the circular arc portion of each adjusting member 663, and the adjusting members 663 are supported by the drive shaft 671 in a rotatable manner. In addition, reinforcement rods 667 are fixed to the pair of adjustment members 663 respectively. It is possible to suppress the width in the left-right direction and respective positional deviation of a pair of adjustment members 663 by the reinforcement rods 667.

The rack 664 meshes with the pinion 662. The pinion 662 is rotated by rotating the strength adjustment shaft 661, thereby the rack 664 is conveyed. As a result, the pair of adjustment members 663 move forwards and backwards centered on the drive shaft 671.

The strength adjustment motor 665 is installed to the left-side base plate 610L. The strength adjustment motor 665 is connected with the controller 70, and operates based on the instructions of the controller 70. Moreover, the power transmission 666 is also installed to the left-side base plate 610L, transmitting the power of the strength adjustment motor 665 to the strength adjustment shaft 661.

The power transmission 666 is formed by combined gears, which herein slow down the rotating speed and increase the output torque of the strength adjustment motor 665. However, the power transmission 666 can be a structure that increases the rotating speed and reduces the output torque of the strength adjustment motor 665. Alternatively, the power transmission 666 is not limited to the combination of gears.

Additionally, in the massage unit 60 of this embodiment, a structure is adopted in which the strength adjustment shaft 661 is rotated by the strength adjustment motor 665 and the power transmission 666, but this is not limited to it, and the strength adjustment motor 665 and the power transmission 666 may also be similarly arranged to the right-side base plate 610R, to synchronously rotate the strength adjustment shaft 661 with the strength adjustment motor 665 and power transmission 666 arranged to the left-side base plate 610L.

As shown in FIGS. 7 to 12, the strength adjustment shaft 661 is arranged at a position further back than the kneading shaft 631, the beating shaft 641, and the width adjustment shaft 651. Moreover, the pair of adjustment members 663 support the kneading shaft 631, the beating shaft 641, and the width adjustment shaft 651 to be rotatable. Therefore, as the adjustment member 663 moves forward and backward centered on the driving shaft 671, the treatment part 62, the kneading mechanism 63, the beating mechanism 64 and the width adjusting mechanism 65 also move forward and backward centered on the driving shaft 671. As shown in FIGS. 10 to 12, the treatment part 62, the kneading mechanism 63, the beating mechanism 64 and the width adjustment mechanism 65, except for the arm 621 and the treatment element 622, are arranged to overlap with the pair of adjustment members 663 when viewed from the side.

Moreover, the pair of adjustment members 663 are formed so as not to protrude from the front of the massage unit 60 when moved to the forefront. Due to the fact that the pair of adjustment members 663 are formed in a manner that do not protrude from the front, the pair of adjustment members 663 can be arranged on the rear side of the backrest 30 rather than on the rear side of the hole 33.

In addition, in the massage unit 60, when the pair of adjustment members 663 move to the forefront, only the arm 621 and the treatment element 622 protrude forwards from the hole 33 of the backrest 30. Moreover, by adjusting the forward and backward positions of the pair of adjustment members 663, it is possible to change the amount by which the arm 621 and the treatment element 622 protrude from the front surface 30F of the backrest 30. The greater the amount by which the treatment device 622 protrudes from the front surface 30F of the backrest 30, the more strongly the treatment strength of the treatment device 622 applied on the recipient. In the strength adjustment mechanism 66, the treatment strength of the treatment element 622 on the body of the recipient can be adjusted based on the position of the pair of adjustment members 663 in the front-back direction.

In addition, it is also possible be configured such that when the adjustment members 663 are located on the far rear side, at least the treatment element 622 protrudes further forwards than the front surface 30F of the backrest 30. Alternatively, it is also possible for the whole massage unit 60 to be positioned behind the front surface 30F of the backrest 30 when the adjustment member 663 is located on the far rear side.

### Lifting Mechanism 67

As shown in FIGS. 7, 8, 10 to 12, etc., the lifting mechanism 67 has a drive shaft 671, a driven shaft 672, a pair of pinions 673, a pair of guide rollers 674, a lifting motor 675, and a power transmission 676. The drive shaft 671 and the driven shaft 672 are both rod members extending in the left-right direction. The two ends of the drive shaft 671 are supported to the left-side base plate 610L and the right-side base plate 610R in a rotatable manner. Two ends of the driven shaft 672 are fixed to the left-side base plate 610L and the right-side base plate 610R. In the massage unit 60, the drive shaft 671 is arranged below the driven shaft 672.

A rotary encoder 677 is arranged on the drive shaft 671, and the rotary encoder 677 is connected to the controller 70 (referred to FIG. 6). By obtaining information from the rotary encoder 677, the controller 70 can obtain the rotation speed, the rotation angle, and other status of the drive shaft 671. In addition, the controller 70 can obtain the position of the massage unit 60 in the up-down direction based on information from the rotary encoder 677.

The two ends of drive shaft 671 in the left-right direction protrude further outwards than the left-side base plate 610L and the right-side base plate 610R respectively. Moreover, the pair of pinions 673 are fixed to portions of both ends of the drive shaft 671 protruding further outwards than the left-side base plate 610L and the right-side base plate 610R in the left-right direction. The pair of pinions 673 rotate together with the drive shaft 671.

In addition, the driven shaft 672, like the drive shaft 671, protrudes further outwards than the left-side base plate 610L and right-side base plate 610R at both ends in the left-right direction. The pair of guide rollers 674 are configured in a rotatable manner to portions of both ends of the driven shaft 672 protruding further outwards than the left-side base plate 610L and the right-side base plate 610R in the left-right direction.

The pinion 673R on the right side of massage unit 60 meshes with the rack of guide rail 31R disposed on the right side. In addition, the pinion 673L on the left side of massage unit 60 meshes with the rack of the rail 31L disposed on the left side. In addition, the guide roller 674L on the left side of the massage unit 60 cooperates with the left-side guide rail 31L in a way to movable on the left-side rail 31L. In addition, the guide roller 674R on the right side of the massage unit 60 cooperates with the right-side rail 31R in a way to movable on the right-side guide rail 31R.

The lifting motor 675 is installed on the left-side base plate 610L. The lifting motor 675 is connected with the controller 70 and operates based on the instructions from the controller 70. Moreover, the power transmission 676 is also installed on the left-side base plate 610L, transmitting the power of the lifting motor 675 to the drive shaft 671. The pinion 673 is rotated by the rotation of the drive shaft 671.

The power transmission 676 is formed by combined gears, which herein slow down the rotating speed and increase the output torque of the lifting motor 675. However, the power transmission 676 can also be configured to increase the rotating speed and reduce the output torque of the lifting motor 675. Alternatively, the power transmission 676 is not limited to the combination of gears.

Additionally, in the massage unit 60 of this embodiment, a structure is adopted in which the drive shaft 671 is rotated by the lifting motor 675 and the power transmission 676, but this is not limited to it, and the lifting motor 675 and the power transmission 676 may also be similarly arranged to the right-side base plate 610R, to synchronously rotate the drive shaft 671 with the lifting motor 675 and power transmission 676 arranged to the left-side base plate 610L.

As shown above, the pair of pinions 673 mesh with the racks disposed on the rails 31R and 31L, and the pair of guide rollers 674 cooperate with the rails 31R and 31L, such that the massage unit 60 is supported by the rails 31R and 31L. Moreover, the massage unit 60 can be raised and lowered along the rails 31R and 31L by rotating the pair of pinions 673.

### First Support 612, Second Support 613

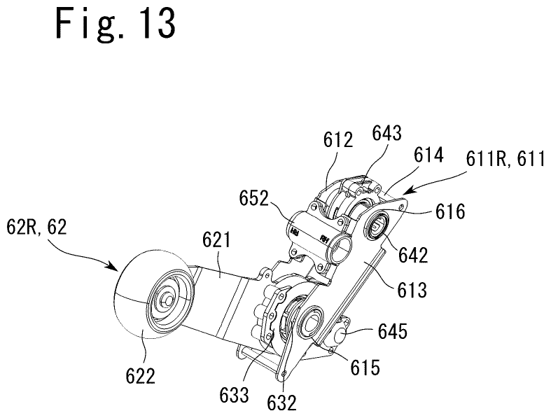

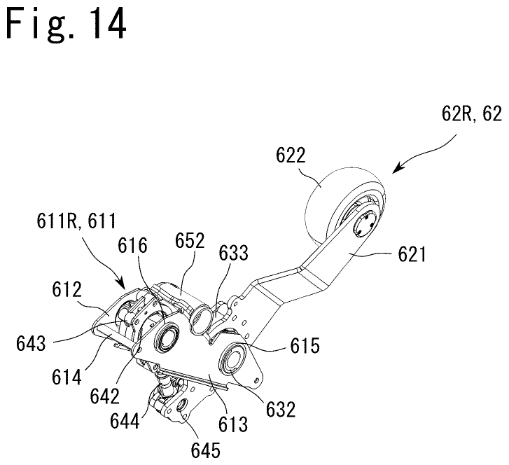

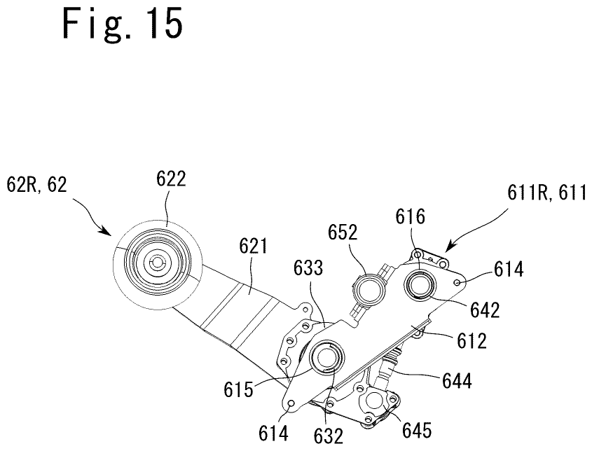

FIG. 13 is a perspective view from the front of the linkage 611 (611R) supporting the treatment part 62. FIG. 14 is a perspective view from the back of the linkage 611 supporting the treatment part 62. FIG. 15 is a side view of the linkage 611R supporting the treatment part 62. Here, the linkage 611R supporting a treatment part 62R on the right side of the massage unit 60 is described. In addition, the left-side linkage 611L is configured to mirror the right-side linkage 611R, and supports a left treatment part 62L.

A first support 612 and a second support 613 of the linkage 611R are bilateral symmetrical. The first support 612 and the second support 613 are shaped to extend in the up-down direction, with their upper ends linked to each other and lower ends linked to each other by pillar members 614. By using the pillar members 614 to link the first support 612 and the second support 613, the first support 612 and the second support 613 are linked with a certain width spaced. The first support 612 and the second support 613 each has a first through hole 615 and a second through hole 616.

When the first support 612 and the second support 613 is linked with the pillar members 614, the first through holes 615 are aligned with each other in the left-right direction, and the second through holes 616 are aligned with each other in the left-right direction. Moreover, in the first support 612 and the second support 613, the first through hole 615 is arranged below the second through hole 616. That is, the first through holes 615 and the second through holes 616 are paired on both sides.

In a state where the first support 612 and the second support 613 are linked by the pillar members 614, the kneading cam 632 is rotatably arranged in the pair of first through holes 615. The kneading cam 632 has flanges at both ends in the left-right direction, which prevent the kneading cam 632 from disengaging from the first through hole 615. In addition, the beating cam 642 is rotatably configured in the pair of second through holes 616. The beating cam 642 has flanges at both ends in the left-right direction, which prevent the beating cam 642 from disengaging from the second through hole 616.

In addition, the first width adjustment guide 652 is secured the outer edges of the first support 612 and the second support 613 across the first support 612 and the second support 613. The first width adjustment guide 652 serves to link the first support 612 and the second support 613. Thus, the first support 612 and the second support 613 are fixed relative to the first width adjustment guide 652, and both can move synchronously with the first width adjustment guide 652. The first width adjustment guide 652 moves in the left-right direction by the rotation of the width adjustment shaft 651. Meanwhile, the first support 612, the second support 613, and the kneading cam 632, the driven ring 633, the beating cam 642, the driven ring 643, the arm 621, and the treatment element 622 supported by the first support 612 and the second support 613 are moved with the movement of the first width adjustment guide 652. Therefore, the first width adjustment guide 652 is installed at a position where the first support 612 and the second support 613 can move in a balanced manner. In addition, in the massage unit 60 of this embodiment, when viewed from the front, the first width adjustment guide 652 is configured between the first through hole 615 and the second through hole 616.

In addition, the first support 612 and the second support 613 of the left-side linkage 611L have the same structures as the first support 612 and the second support 613 of the right-side linkage 611R. That is, a kneading cam 632 and a beating cam 642 are installed on the first support 612 and the second support 613 of the left-side linkage 611L. Additionally, a second width adjustment guide 653 is fixed on the first support 612 and the second support 613 of the left-side linkage 611L.

As described above, the kneading shaft 631, the beating shaft 641, and the width adjustment shaft 651 are linked by the plate-shaped first support 612 and the second support 613. Therefore, if the linkage 611 moves in the left-right direction, the first support 612 and the second support 613 move in the left-right direction while maintaining their positional relationship with the kneading shaft 631, the beating shaft 641, and the width adjustment shaft 651. Therefore, when the linkage 611 moves in the left-right direction with the rotation of the width adjustment shaft 651, it also moves along the kneading shaft 631 and the beating shaft 641 in the width direction. Due to the fact that the kneading shaft 631 and the beating shaft 641 are linked to the width adjustment shaft 651 only through the plate-shaped first support 612 and second support 613, it is possible to construct them with fewer components, and to stably move the treatment element 622 in the width direction while it is performing kneading and beating actions. As a result, a large-range treatment can be implemented and treatment modes can also be increased.

### Treatment at Sites of the Recipient

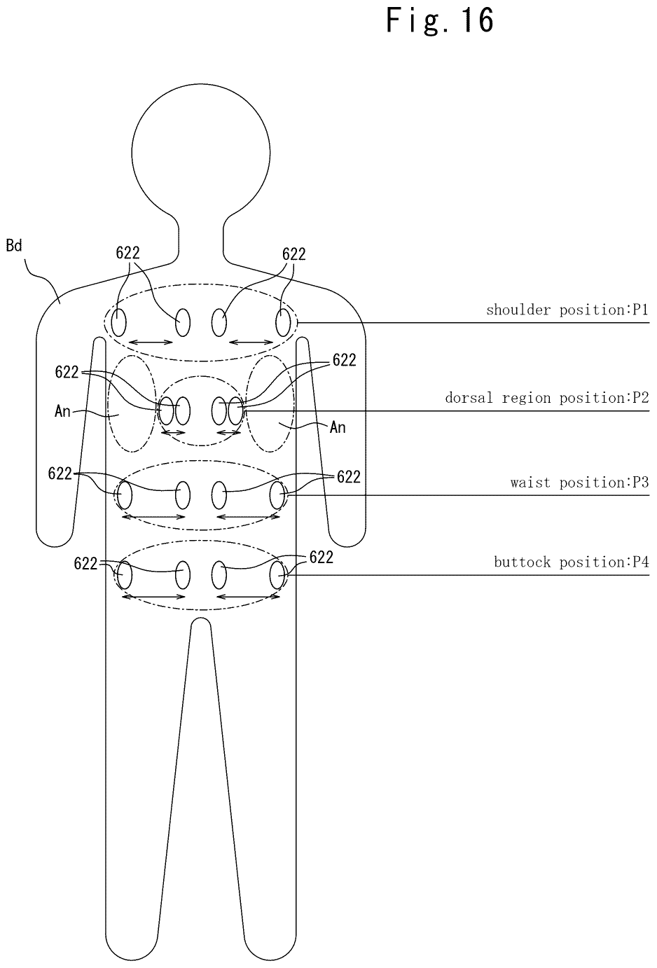

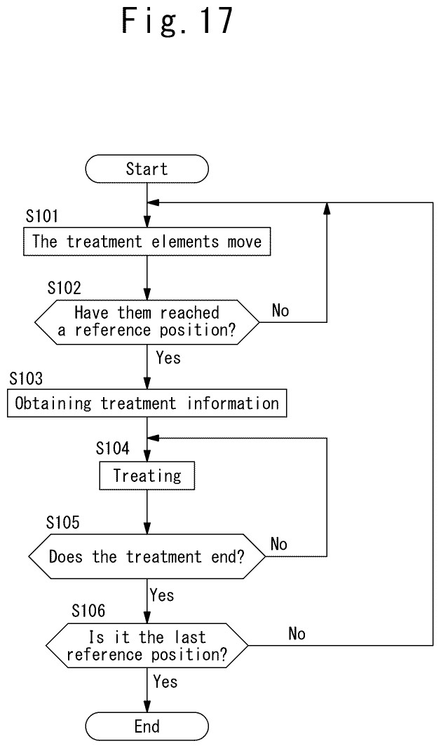

FIG. 16 is a schematic diagram showing the body Bd of the recipient and the movement range of the treatment elements 622. FIG. 17 is a flowchart showing the steps of treatment. The arm 621 of the treatment part 62 passes through the hole 33 of the backrest 30 and protrudes forwards. Moreover, generally, there are muscles in the shoulders, waist, and buttocks of the body Bd of the recipient over a large area in the left-right direction, while muscles are concentrated in the central portion on the dorsal region in the left-right direction. Therefore, for the dorsal region located between the shoulders and the waist, the massage unit can be operated in a way that the width between the treatment elements is narrower than that between the shoulders and the waist. Information associated with the treatment width and method at sites may also be stored in the storage unit 72.

As shown in FIG. 16, the shoulder position P1, dorsal region position P2, waist position P3, and buttock position P4 of the body Bd of the recipient are stored in the storage unit 72 as information of the positions in the up-down direction. In other words, the storage unit 72 of the massage machine 100 pre-stores the positions of the treatment part 62 in the up-down direction corresponding to each position of the body Bd of the recipient (the shoulder position P1, the dorsal region position P2, the waist position P3, and the buttock position P4). In this embodiment, values predetermined by the massage machine 100 are used, but it can also be adjusted by the recipient or by measurement as described below.

In addition, the shoulder position P1, the dorsal region position P2, the waist position P3, and the buttock position P4 (hereinafter referred to as reference positions) may represent the positions of specific points in the up-down direction, or certain ranges in the up-down direction. In this embodiment, the reference position represents a certain range.

As shown in FIG. 17, the controller 70 operates the lifting motor 675 to move the massage unit 60 (step S101). For example, the massage unit 60 moves and performs treatment in the order of the reference position (shoulder position) P1, the reference position (dorsal region position) P2, the reference position (waist position) P3, and the reference position (hip position) P4. The controller 70 can obtain the position of the massage unit 60 in the up-down direction based on information from the rotary encoder 677 of the lifting mechanism 67. Further, in massage machine 100, and in the measurement of the body of the recipient, the positions of the body parts are measured starting from the upper shoulders and moving downwards. It is also possible to measure the positions of body parts from the lower buttocks and moving upwards in reverse. Thus, the controller 70 can set the position information of each reference position based on the position information of the measured body parts.

The controller 70 determines whether the treatment elements 622 have reached a predetermined reference position (such as reference position P1, the shoulder position) (step S102). As described above, the controller 70 obtains the position of the massage unit 60 in the up-down direction based on information from the rotary encoder 677, and determines whether the treatment elements 622 have reached the reference position based on the position in the up-down direction.

Before the treatment elements 622 reach the reference position (during the period of “no” in step S102), steps S101 and S102 are repeated, and the controller 70 continues to operate the lifting motor 675. In addition, when the treatment elements 622 reach the reference position (in the case of “Yes” in step S102), the controller 70 stops the operation of the lifting motor 675 and retrieves treatment information from the storage unit 72, including the treatment range in the left-right direction, the treatment direction, and the treatment strength at the site (the shoulders) corresponding to the current reference position (e. g., reference position P1) (step S103). In addition, the obtained treatment information may also include at least one of: the treatment range in the left-right direction, the treatment direction, and the treatment strength corresponding to the current reference position.

As mentioned above, the treatment range in the left-right direction is set according to the body parts of the recipient. In addition, the treatment range in the left-right direction is also set related to the first width W1 of the first area 331 and the second width W2 of the second area 332, which are the shape of the hole 33 of the backrest 30. In addition, the treatment method can be selected from only kneading action, only beating action or concurrent action of kneading action and beating action. The treatment strength is set, for example, by performing strong treatment on the shoulders and the waist, and weak treatment on the dorsal region. The information may be input from the input unit 82 of the operation section 80 or the portable terminal owned by the recipient, or may be stored as a predetermined treatment course and selected for use according to requirements of the recipient. In addition, the treatment information also includes specific treatment actions, which herein may also include information about a specific action prohibited area An where a certain action cannot be performed, such as a specific action prohibited area An where kneading or beating action cannot be performed. In addition, as treatment information, it can also include action information, such as determining the actions of the kneading mechanism, the beating mechanism, the width adjustment mechanism, and the strength adjustment mechanism for different body parts of the recipient.

Then, the controller 70 implements the treatment of the treatment element 622 based on the treatment information (step S104). In addition, during the treatment of the treatment element, the controller 70 causes at least one of the kneading motor 634 and the beating motor 640 based on the treatment information actuates and executes the treatment action specified by the treatment information.

At this time, the treatment can be configured to perform kneading action by the kneading mechanism 63 and/or beating action by the beating mechanism 64 while temporarily stopping the movement of the treatment part 62 in the left-right direction, or to move the treatment part 62 in the left-right direction while performing kneading action and/or beating action. In addition, it can also include treatment achieved by actions of the inflation and contraction part 35. In addition, when the treatment strength at the reference position is specified in the treatment information, the controller 70 actuates the strength adjustment motor 665 and adjust the position of the trajectory Cbt depicted by the center of the treatment element 622 in the front-rear direction.

In addition, with regard to the strength of the treatment, there are cases where it remains constant at the reference position, and cases where it varies depending on the left-right position of the treatment element 622. In the case of the strength changing according to the position of the treatment element 622 in the left-right direction, the controller 70 actuates the strength adjustment motor 665 so that the strength of the treatment varies as predetermined depending on the position of the treatment element 622. That is, the controller 70 can synchronize the actions of at least one of the kneading mechanism 63 and the beating mechanism 64 with the strength adjustment mechanism 66 based on the position of the massage unit 60.

Then, the controller 70 determines whether the treatment at the current reference position has ended (step S105). For example, the controller 70 may also end the treatment at a reference position based on the implementation time of the treatment. In addition, at a reference position, the treatment is sometimes performed by reciprocating the treatment element 622 a certain number of times in the left-right direction. In such a case, based on that the number of reciprocating movement of the treatment element 622 in the left-right direction reaches the specified number, or that the movement distance of the treatment element 622 reaches the specified distance, the controller 70 can end the treatment at a reference position.

During the period when the end of the treatment is not determined (the period of “no” in step S105), steps S104 and S105 are repeated, and the controller 70 continues the treatment at the current reference position. In addition, when it is determined that the treatment has ended (in the case of “Yes” in step S105), the controller 70 determines whether the current reference position is the last reference position among all the reference positions to be performed treatment according to the predetermined treatment sequence (step S106). If the current reference position is not the last reference position in the predetermined treatment sequence (in the case of “No” in step S106), the process returns to step S101, and the controller 70 uses the above method to move the massage unit 60 to the next reference position in the treatment sequence and continue the treatment. In addition, if the current reference position is the last reference position (in the case of “Yes” in step S106), the process ends. The selection of each reference position involved in the above treatment sequence is not limited to this, and can be chosen as needed. For example, the treatment sequence can be set to only include shoulder position P1, dorsal region position P2, and waist position P3. The order of treatment for each reference position is not limited to the above treatment sequence and can be set as needed. For example, shoulder position P1 may be set as the initial reference position for treatment, while waist position P3 may be set as the final reference position, and vice versa.

As shown above, the massage machine 100 may change the width in the left-right direction, treatment method, and strength of the treatment according to the up-down position of the massage unit 60, and performs the treatment accordingly. Therefore, it is able to apply appropriate treatments to different parts of the body without excessive or insufficient treatment, which improves the effectiveness of treatment.

### Body Measurement (Somatotype Measurement) Action

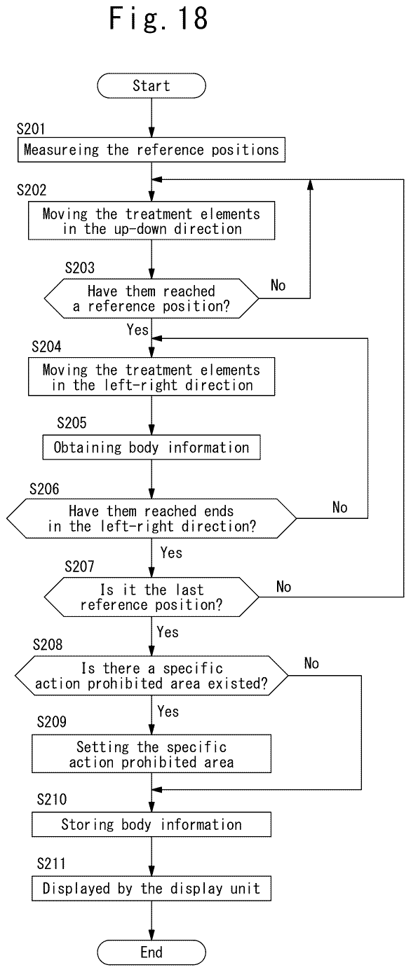

In the treatment according to the flowchart shown in FIG. 17, it is configured to set predetermined positions in the up-down direction as reference positions and perform treatment in the width direction. On the other hand, the positions and widths of the shoulders, dorsal region, waist, buttocks, and other parts of the body Bd of the recipient are different in the up-down direction. In order to cope with the differences in different parts of the body Bd of one recipient and the differences in somatotype between different recipients, the massage machine 100 has the function of measuring the body parts of the recipient. The steps for measuring the body parts of the recipient are described below. FIG. 18 is a flowchart showing the body measurement action.

As shown in FIG. 18, the controller 70 brings the treatment elements 622 into contact with the body Bd of the recipient and measures various reference positions in the up-down direction of the body Bd of the recipient (step S201). For example, the shoulder position P1, dorsal region position P2, waist position P3, and buttock position P4 are measured as the reference positions P1, P2, P3, and P4 for each part respectively. In addition, the body Bd of the recipient bends in the same way as the curvature of the spine. Narrowing the width of the left-right direction of a pair of treatment elements 622, and actuating the lifting motor 675 to move the treatment elements 622 in the up-down direction while in contact with the body Bd of the recipient. Moreover, in the strength adjustment motor 665, an electromotive force is generated due to the force or load from the body Bd of the recipient. The controller 70 measures the bending of the body Bd of the recipient in the up-down direction based on the load acting on the strength adjustment motor 665, thereby measuring the reference position at the part of the body Bd of the recipient.

In addition, the controller 70 may set the shoulder position P1, dorsal region position P2, waist position P3, and buttock position P4 based on the measurement results, and it can also estimate the somatotype and set the remaining reference positions based on other reference positions such as the shoulder position P1 after setting any one of the reference positions. In addition, for each reference position, the recipient may also manually adjust it.

The controller 70 actuates the lifting motor 675 to move the massage unit 60 in the up-down direction (step S202). At this time, the controller 70 can obtain the position of the massage unit 60 in the up-down direction based on information from the rotary encoder 677 of the lifting mechanism 67. In addition, in massage machine 100, and in the measurement of the body of the recipient, the positions of the body parts are measured starting from the upper shoulders and moving downwards. It is also possible to measure the positions of the body parts from the lower buttocks and moving upwards in reverse.

The controller 70 determines whether the treatment elements 622 have reached a reference position (step S203). As described above, the controller 70 obtains the position of the massage unit 60 in the up-down direction based on information from the rotary encoder 677, and determines whether the treatment elements 622 have reached a reference position based on the position in the up-down direction.

Before the treatment elements 622 reach a reference position (during the period of “No” in step S102), steps S202 and S203 are repeated, and the controller 70 continues to operate the lifting motor 675. In addition, when the treatment elements 622 reach the reference position (in the case of “Yes” in step S203), the controller 70 stops the operation of the lifting motor 675 and actuates the width adjustment motor 654 to move the treatment elements 622 in the left-right direction (step S204). The controller 70 obtains the positions of the treatment elements 622 in the left-right direction based on information from a sensor, such as the rotary encoder 658.

The controller 70 performs the following control, i.e., pressing the treatment elements 622 against the body Bd of the recipient and moves the treatment elements 622 in the left-right direction. The treatment element 622 is pressed by the body Bd of the recipient, and an electromotive force corresponding to a load acting on the treating elements 622 is generated in the strength adjustment motor 665. The controller 70 obtains the electromotive force as the load acting on the treatment elements 622, and obtains information about the body Bd of the recipient (step S205). In addition, examples of information about the body Bd of the recipient may be given as the width and curvature of the body Bd of the recipient. In addition, various information related to the body Bd of the recipient, such as somatotype, can be inferred from the load on the treatment device 622.

The controller 70 determines whether the ends of the body Bd at the current reference position in the left-right direction have been reached (step S206). The controller 70 detects the concave-convex of the body Bd of the recipient based on the load on the strength adjustment motor 665. Therefore, the controller 70 determines that the treatment device 622 have been reached the ends of the body Bd at the reference position based on the load acted on the strength adjustment motor 665 becoming less than a certain value.

If the treatment elements 622 have not reached the current reference position of the body Bd (in the case of “No” in step S206), repeat steps S204 to S206, and the controller 70 continues the movement of the treatment elements 622 in the left-right direction and the acquisition of information about the body Bd of the recipient. In addition, when the treatment elements 622 reach the ends in the left-right direction at the current reference position of the body Bd (in the case of “Yes” in step S206), the controller 70 determines whether the current reference position is the last reference position among all reference positions that need to be performed treatment according to the predetermined treatment sequence (herein, for example, the buttock position P4) (step S207).

In the case where the current reference position is not the last reference position (such as the lowest buttock position P4) (in the case of “No” in step S207), steps S202 to S207 are repeated, and the controller 70 actuates the lifting motor 675 to move the massage unit 60 towards the next reference position in the predetermined treatment sequence. In addition, in the case where the current reference position is the last reference position (in the case of “Yes” in step S207), the controller 70 determines whether information about a specific action prohibited area An is recorded for that reference position (step S208). When there is information about a specific action prohibited area An, the controller 70 sets a specific action prohibited area An where one of the kneading action and the beating action is not performed.

In the above example, the controller 70 determines whether the information of the last reference position has a specific action prohibited area An, and sets it after determination, it is also possible for the controller 70 to determine whether each reference position has information about a specific action prohibited area An one by one. An example of a specific action prohibited area An may be given as an area where the beating action is not performed on the less muscular parts at the ends of the dorsal region in the left-right direction. In addition, sometimes for example it is also set an area in a portion of the shoulders where the kneading action is not performed. For a specific action prohibited area An, it can be set according to predetermined conditions, or input by the recipient through the input unit 82 or a portable terminal held by the recipient.

In the case where there is a specific action prohibited area An (in the case of “Yes” in step S208), the specific action prohibited area An corresponding to the body Bd of the recipient is set with reference to the information of the measured body Bd of the recipient (step S209). If there is no specific action prohibited area An (in the case of “NO” in step S208) or if a specific action prohibited area An is set (step S209), the controller 70 digitizes and stores the measured information of the body Bd of the recipient in the storage unit 72 (step S210).

The controller 70 may also store the body information in the storage unit 72 in association with the personal information that identifies the recipient. In addition, it is also possible to delete the body information of the recipient at the end of each treatment without identifying the personal identity of the recipient. Examples of the end of the treatment may be given as when the main power of massage machine 100 is turned off, or when switching treatment process such as from automatic treatment to manual treatment, etc.

The controller 70 displays the information of the body Bd of the recipient stored in the storage unit 72 on the display unit 81 (step S211). Meanwhile, it can also be displayed on the display of the portable terminal held by the recipient.

In the massage machine 100, in addition to the contours of the body Bd of the recipient in the up-down direction, it may also measure the contours at predetermined positions in the up-down direction or at predetermined positions of the body Bd in the left-right direction. Therefore, by controlling the movement of the treatment element 622 based on the contours in the left-right direction, the treatment effect can be improved.

### Actions of the Treatment Element 622

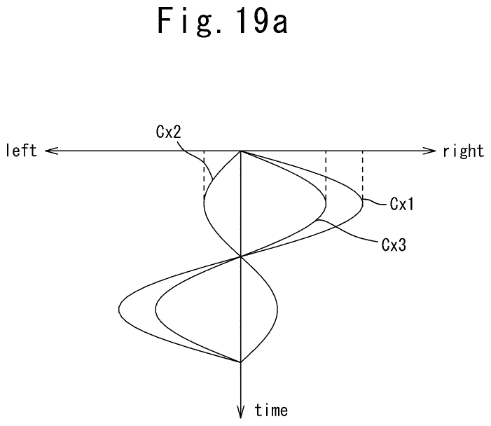

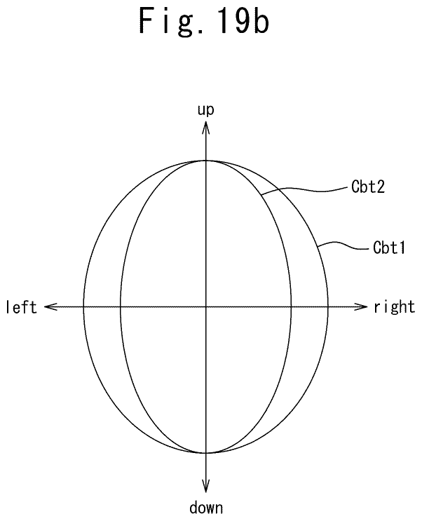

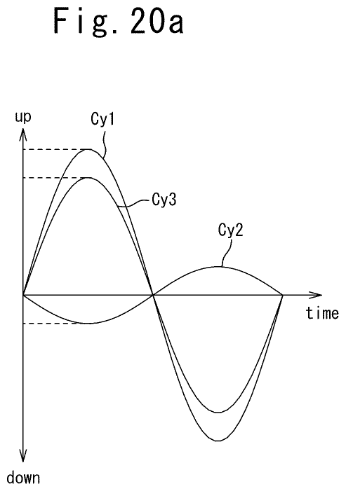

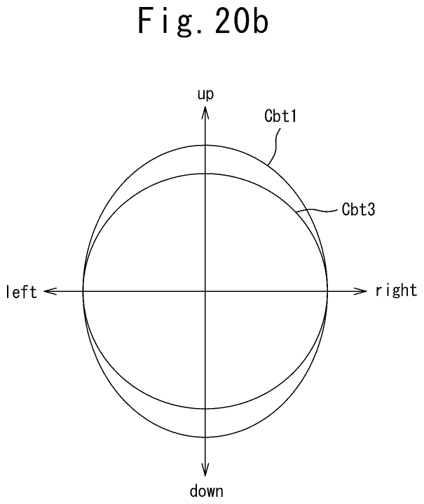

Here, the action of the width adjustment mechanism 65 corresponding to the action of the kneading mechanism 63 is described. FIG. 19a is a diagram presenting the position of the treatment element 622 and the first width adjustment guide 652 in the left-right direction during kneading. FIG. 20a shows the positions of the treatment element 622 and of the drive shaft 671 in the up-down direction during kneading. In addition, FIGS. 19b and 20b further show the trajectory Cbt. In FIG. 19a, the longitude axis represents time, with time progressing from top to bottom. In addition, the horizontal axis represents the position of the center of the treatment element 622 in the left-right direction. Thus, the position of the treatment element 622 in the left-right direction for a specified time is shown. In FIG. 20a, the horizontal axis represents time, with time progressing from the left to the right. In addition, the longitude axis represents the position of the center of the treatment element 622 in the up-down direction. Thus, the position of the treatment element 622 in the up-down direction for a specified time is shown. In addition, FIG. 19b shows the trajectory Cbt of the treatment element, with the longitude axis representing the up-down direction and the horizontal axis representing the left-right direction. Thus, the trajectory Cbt of the treatment element 622 is shown. Similarly, FIG. 20b shows the trajectory Cbt of the treatment element, with the longitude axis representing the up-down direction and the horizontal axis representing the left-right direction. Thus, the trajectory Cbt of the treatment element 622 is shown.

As shown in FIG. 19b, when the kneading mechanism 63 is in action, the center of the treatment element 622 moves along the trajectory Cbt1 with a width in the left-right direction. In the massage unit 60 of this embodiment, the trajectory Cbt1 has a roughly elliptical shape with the up-down direction as the long axis, and the center of the treatment element 622 reciprocates within a certain range in the left-right direction at a certain cycle. In addition, actuating the width adjustment mechanism 65 is able to move the center of the treatment element 622 in the left-right direction.

As shown in FIG. 19a. the position of the center of the treatment element 622 in the left-right direction over time caused by the actuation of the kneading mechanism 63 is referred to as Cx1, and the position of the center of the treatment element 622 in the left-right direction caused by the actuation of the width adjustment mechanism 65 is referred to as Cx2.

The controller 70 synchronously actuates the kneading mechanism 63 and the width adjustment mechanism 65. Therefore, the positions Cx1 and Cx2 change synchronously.

The controller 70 then synchronously actuates the kneading mechanism 63 and the width adjustment mechanism 65 to reverse the phase of position Cx1 and position Cx2. As a result, the position of the center of the treatment element 622 reaches in the left-right direction over time is as shown in Cx3, forming a shape where position Cx2 counteracts position Cx1. As a result, the width of the trajectory Cbt2 in the left-right direction depicted by the center of the treatment element 622 when the kneading mechanism 63 and the width adjustment mechanism 65 are synchronously actuated becomes narrower than the width of the trajectory Cbt1 in the left-right direction depicted by the center of the treatment element 622 when only the kneading mechanism 63 is actuated.

When the treatment element 622 performs kneading action, narrowing the width of the trajectory Cbt enables to perform small rotational movements, known as kneading and rubbing, in the state of locally applying pressure to the stiff part of the muscle. As described above, the controller 70 can perform more concentrated kneading and rubbing in the left-right direction by driving the width adjustment motor 654 of the width adjustment mechanism 65 in the opposite direction to the movement direction of the treatment element 622 in the left-right direction caused by the actuation of the kneading mechanism 63.

In addition, in FIGS. 19a and 19b, the controller 70 controls the width adjustment motor 654 so that the first width adjustment guide 652 moves to the left end of the movable range when the treatment member 622 is located at the right end due to the actuation of the kneading mechanism 63. As a result, the maximum width of the trajectory Cbt2 in the left-right direction depicted by the center of the treatment element 622 when the kneading mechanism 63 and the width adjustment mechanism 65 are concurrently actuated becomes minimal.

In addition, as shown in FIGS. 19a and 19b, for ease of understanding, the position Cx1 of the center of the treatment element 622 in the left-right direction when moving along the trajectory Cbt1 is set to be sinusoidal, but it is not limited to this. An example of the positions of the center of the treatment element 622 in the left-right direction may be given as actions of reciprocating movement with a certain cycle and amplitude in the left-right direction. In addition, the position Cx2 of the center of the treatment element 622 in the left-right direction due to the movement of the width adjustment mechanism 65 also forms a sinusoidal wave shape consistent with the position Cx1, but is not limited to this. In addition, in this embodiment, the cycles of positions Cx1 and Cx2 are completely synchronized, but they may also be offset as long as at least a portion of the actions of the treatment member 622 in the left-right direction caused by the actuation of the kneading mechanism 63 can be counteracted by the actuation of the width adjustment mechanism 65.

As shown in FIG. 20b, the trajectory Cbt1 depicted by the center of the treatment element 622 during the actuation of the kneading mechanism 63 has a width in the up-down direction. At this time, the center of the treatment element 622 moves reciprocally within a certain range in the up-down direction with a certain cycle. In addition, by actuating the lifting mechanism 67, the center of the treatment element 622 can be moved in the up-down direction.

As shown in FIG. 20a. the position of the center of the treatment element 622 in the up-down direction over time caused by the actuation of the kneading mechanism 63 is referred to as Cy1, and the position of the center of the treatment element 622 in the up-down direction caused by the actuation of the lifting mechanism 67 is referred to as Cy2. The controller 70 synchronously actuates the kneading mechanism 63 and the lifting mechanism 67. Therefore, the positions Cy1 and Cy2 change synchronously.

The controller 70 then synchronously actuates the kneading mechanism 63 and the lifting mechanism 67 to reverse the phase of position Cy1 and position Cy2. As a result, the position of the center of the treatment element 622 reaches in the up-down direction over time is as shown in Cy3, forming a shape where position Cy2 partially counteracts position Cy1. As a result, the width of the trajectory Cbt3 in the up-down direction depicted by the center of the treatment element 622 when the kneading mechanism 63 and the lifting mechanism 67 synchronously are actuated becomes narrower than the width of the trajectory Cbt1 in the up-down direction depicted by the center of the treatment element 622 when only the kneading mechanism 63 is actuated.

The controller 70 can perform more concentrated kneading and rubbing in the up-down direction by driving the lifting motor 675 of the lifting mechanism 67 in the opposite direction to the movement direction of the treatment element 622 in the up-down direction caused by the actuation of the kneading mechanism 63.

In addition, in FIGS. 20a and 20b, the controller 70 controls the lifting motor 675, such that when the treatment member 622 is located at an end in the up-down direction due to the actuation of the kneading mechanism 63, it is moved to the opposite end of the movable range of the treatment member 622 in the up-down direction. As a result, the maximum width of the trajectory Cbt3 in the up-down direction depicted by the center of the treatment element 622 when the kneading mechanism 63 and the lifting mechanism 67 are synchronously actuated becomes minimal.

In addition, as shown in FIGS. 20a and 20b, for ease of understanding, the position Cy1 of the center of the treatment element 622 in the up-down direction when moving along the trajectory Cbt1 is set to be sinusoidal, but it is not limited to this. An example of the positions of the center of the treatment element 622 in the up-down direction may be given as actions of reciprocating movement with a certain cycle and amplitude. In addition, the position Cy2 of the center of the treatment element 622 in the up-down direction due to the movement of the lifting mechanism 67 also forms a sinusoidal wave shape consistent with the position Cy1, but is not limited to this. In addition, in this embodiment, the cycle of positions Cy1 and Cy2 are completely synchronized, but they may also be offset as long as at least a portion of the actions of the treatment member 622 in the up-down direction caused by the actuation of the kneading mechanism 63 can be counteracted by the actuation of the lifting mechanism 67.

Moreover, the controller 70 is capable of implementing kneading and rubbing, which can synchronously actuate the kneading mechanism 63, the width adjustment mechanism 65, and the lifting mechanism 67 to cause both the maximum value (width) in the left-right direction and the maximum value (width) in the up-down direction of the trajectory Cbt smaller than when only the kneading mechanism 63 is actuated. In addition, by using the massage unit 60 of this embodiment, it is possible to apply the beating action implemented by the beating mechanism 64 while the treatment element 622 is implementing kneading and rubbing. As a result, the treatment effect of the treatment element 622 can be further improved.

The controller 70 synchronously actuates the kneading mechanism 63 and the width adjustment mechanism 65 as shown in the trajectory Cbt2 in FIG. 19b to cause the maximum value in the left-right direction to be smaller than when only the kneading mechanism 63 is actuated, and actuates the lifting mechanism 67 as shown in the trajectory Cbt3 in FIG. 20b to cause the maximum value in the up-down direction to be smaller than when only the kneading mechanism 63 is actuated.

For example, in the case where the treatment site is lengthwise, the controller 70 synchronizes the kneading mechanism 63 and the width adjustment mechanism 65 to minimize the maximum value of the trajectory Cbt in the left-right direction, and continuously actuates the lifting mechanism 67 to enable kneading and rubbing after reducing the maximum value of the trajectory Cbt in the up-down direction.

Further, in the case where the longitudinal width of the treatment site is small, the controller 70 synchronizes the kneading mechanism 63 and the lifting mechanism 67 to minimize the maximum value of the trajectory Cbt in the up-down direction, and synchronously actuates the width adjustment mechanism 67 to enable kneading and rubbing after reducing the maximum value of the trajectory Cbt in the left-right direction.

Moreover, the massage unit 60 of this embodiment can simultaneously perform kneading and rubbing actions that need concurrent actuations of the kneading mechanism 63, the width adjustment mechanism 65, and the lifting mechanism 67, as well as the beating action implemented by the beating mechanism 64. Therefore, the movement range of the treatment element 622 during kneading can be reduced to improve the kneading and rubbing effect, and the treatment effect can be further improved by applying the beating action.

The embodiments and variations of the present disclosure have been described above, but the various structures and their combinations in the embodiments are only examples, and additions, omissions, replacements, and other changes to the structures may be made without departing from the scope of the present disclosure. Furthermore, the present disclosure is not limited by the embodiments.

### Summary

The present disclosure has the following structure.
(1) A massage unit, comprising:
a pair of treatment elements;
a kneading mechanism being capable of moving the pair of treatment elements in a manner such that the center of each of the treatment elements describes a trajectory having widths in an up-down direction and a left-right direction;
a beating mechanism being capable of moving the pair of treatment elements back and forth in a front-rear direction;
a width adjustment mechanism being capable of adjusting a width between the pair of the treatment elements in the left-right direction; and
a linkage linking the kneading mechanism, the beating mechanism, and the width adjustment mechanism,
the linkage moves in the left-right direction through the width adjustment mechanism.
(2) The massage unit according to (1), wherein comprising a pair of treatment parts including a pair of arms, which support the pair of treatment elements, respectively, and the linkage includes a pair of support arranged on left and right sides of each treatment part and supporting the treatment parts.
(3) The massage unit according to (2), wherein the kneading mechanism includes a kneading shaft extending in the left-right direction and a cam for kneading action that can rotate with the kneading shaft and move along the kneading shaft, and the arm is actuated by the rotation of the cam for kneading action, the kneading shaft is supported on each of the supports in a rotatable manner, and the cam for kneading action is arranged between the pair of supports and supported to each of the pair of supports in a rotatable manner.
(4) The massage unit according to (2) or (3), wherein the beating mechanism includes: a beating shaft extending in the left-right direction, a cam for beating action being able to rotate with the beating shaft and move along the beating shaft, and a rod connecting the cam for beating action with the arm and converting a rotation of the cam for beating action into a movement of the arms in the front-rear direction,
the beating shaft is supported on each of the supports in a rotatable manner, and the cam for beating action is arranged between the pair of supports and supported to each of the pair of supports in a rotatable manner.
(5) The massage unit according to any one of (2) to (4), wherein the width adjustment mechanism has a width adjustment shaft extending in the left-right direction, and a width adjustment guide installed on the width adjustment shaft and being able to move in the left-right direction according to the rotation of the width adjustment shaft, and the width adjustment guide is fixed to each of the pair of the supports.
(6) A massage machine comprising a massage unit according to any one of (1) to (5), and providing treatment to a body of a recipient who is seated,
including a backrest that supports a back of the recipient,
the massage unit is disposed in a hole of the backrest extending in the up-down direction, and is configured in a manner that can move along the hole.

### INDUSTRIAL USABILITY

The present disclosure can be used as a chair-type massage machine for massaging the body of the recipient.

### DESCRIPTION OF REFERENCE NUMBERS

100 Massage machine;
10 Base;
20 Seat;
30, 30A, 30B, 30C Backrest;
30F Front surface;
31L, 31R Rail;
33 Hole;
331, 331d, 331u First area;
332 Second area;
34, 34a Protrusion;
35 Inflation and contraction parts;
40 Arm treatment part;
50 Leg treatment part;
51 Recess;
60 Massage unit;
61 Base;
610L, 610R Base plate;
611, 611L, 611R Linkage;
612 First support;
613 Second support;
614 Pillar member;
615 First through hole;
616 Second through hole;
617 Bracket;
62 Treatment part;
62L Left treatment part;
62R Right treatment part;
621 Arm;
622 Treatment element;
63 Kneading mechanism;
631 Kneading shaft;
632 Kneading cam;
633 Driven ring;
634 Kneading motor;
635 Power transmission;
636 Rotary encoder;
64 Beating mechanism;
640 Beating motor;
641 Beating shaft;
642 Beating cam;
643 Driven ring;
644 Rod;
645 Rod connector;
646 Power transmission;
647 Rotary encoder;
65 Width adjustment mechanism;
651 Width adjustment shaft;
652 First width adjustment guide;
653 Second width adjustment guide;
654 Width adjustment motor;
655 Power transmission;
656 First thread;
657 Second thread;
658 Rotary encoder;
66 Strength adjustment mechanism;
661 Strength adjustment shaft;
662 Pinion;
663 Adjustment member;
664 Rack;
665 Strength adjustment motor;
666 Power transmission;
667 Reinforcement rods;
668 Rotary encoder;
67 Lifting mechanism;
671 Drive shaft;
672 Driven shaft;
673 Pinion;
674 Guide roll;
675 Lifting motor;
676 Power transmission;
677 Rotary encoder;
70 Controller;
71 Processor;
72 Memory;
80 Operation section;
81 Display unit;
82 Input unit.

1. A massage unit comprising:
a pair of treatment elements;
a kneading mechanism configured to move the pair of treatment elements in a manner such that the center of each of the treatment elements describes a trajectory having widths in an up-down direction and a left-right direction;
a beating mechanism configured to move the pair of treatment elements back and forth in a front-rear direction;
a width adjustment mechanism configured to adjust a width between the pair of the treatment elements in the left-right direction; and
a linkage linking the kneading mechanism, the beating mechanism, and the width adjustment mechanism, the linkage moving in the left-right direction through the width adjustment mechanism.

2. The massage unit according to claim 1, comprising
a pair of treatment parts including a pair of arms which support the pair of treatment elements, respectively,
the linkage including a pair of support arranged on left and right sides of each of the treatment parts and supporting the treatment parts.

3. The massage unit according to claim 2, wherein
the kneading mechanism includes a kneading shaft extending in the left-right direction and a cam for kneading action that is rotatable with the kneading shaft and movable along the kneading shaft, and the arm is actuated by a rotation of the cam for kneading action,
the kneading shaft is supported to each of the supports in a rotatable manner, and the cam for kneading action is arranged between the pair of supports and supported to each of the pair of supports in a rotatable manner.

4. The massage unit according to claim 2, wherein
the beating mechanism includes a beating shaft extending in the left-right direction, a cam for beating action being rotatable with the beating shaft and movable along the beating shaft, and a rod connecting the cam for beating action with the arm and converting a rotation of the cam for beating action into a movement of the arm in the front-rear direction,
the beating shaft is supported to each of the supports in a rotatable manner, and the cam for beating action is arranged between the pair of supports and supported to each of the pair of supports in a rotatable manner.

5. The massage unit according to claim 2, wherein
the width adjustment mechanism includes a width adjustment shaft extending in the left-right direction, and a width adjustment guide installed on the width adjustment shaft and movable in the left-right direction according to the rotation of the width adjustment shaft,
the width adjustment guide is fixed to each of the pair of the supports.

6. A massage machine configured to provide treatment to a body of a recipient who is seated, the massage machine comprising:
a backrest configured to support a dorsal region of the recipient; and
the massage unit according to claim 1, the massage unit being disposed in a hole of the backrest extending in the up-down direction, and being movable along the hole.

7. A massage machine configured to provide treatment to a body of a recipient who is seated, the massage machine comprising:
a backrest configured to support a dorsal region of the recipient; and
the massage unit according to claim 2, the massage unit being disposed in a hole of the backrest extending in the up-down direction, and being movable along the hole.

8. A massage machine configured to provide treatment to a body of a recipient who is seated, the massage machine comprising:
a backrest configured to support a dorsal region of the recipient; and
the massage unit according to claim 3, the massage unit being disposed in a hole of the backrest extending in the up-down direction, and being movable along the hole.

9. A massage machine configured to provide treatment to a body of a recipient who is seated, the massage machine comprising:
a backrest configured to support a dorsal region of the recipient; and
the massage unit according to claim 4, the massage unit being disposed in a hole of the backrest extending in the up-down direction, and being movable along the hole.

10. A massage machine configured to provide treatment to a body of a recipient who is seated, the massage machine comprising:
a backrest configured to support a dorsal region of the recipient; and
the massage unit according to claim 5, the massage unit being disposed in a hole of the backrest extending in the up-down direction, and being movable along the hole.
